(19) United States
(12) Patent Application Publication
(10) Pub. No.: US 2009/0194685 A1
(43) Pub. Date: Aug. 6, 2009

(54) HIGH-THROUGHPUT SCREENING OF METABOLIC DISORDERS USING A LASER DESORPTION ION SOURCE COUPLED TO A MASS ANALYZER

(75) Inventors: John J. Corr, Richmond Hill (CA); Zoe A. Quinn, Vernon (CA); Bori Shushan, Toronto (CA)

Correspondence Address: MCKEE, VOORHEES & SEASE, P.L.C., 801 GRAND AVENUE, SUITE 3200, DES MOINES, IA, 50309-2721, US

(73) Assignees: MDS ANALYTICAL TECHNOLOGIES, Concord (CA); LIFE TECHNOLOGIES CORPORATION, Carlsbad, CA (US)

(21) Appl. No.: 12/362,796

(22) Filed: Jan. 30, 2009

Related U.S. Application Data
(60) Provisional application No. 61/025,052, filed on Jan. 31, 2008.

(51) Int. Cl. B01D 59/44; H01J 49/00

(52) U.S. Cl. 250/282; 250/281

(57) ABSTRACT

Methods and kits for high throughput screening and analysis of metabolic disorders using a laser desorption ion source coupled to a mass analyzer (for example, MALDI) are provided. The metabolic disorders can be amino acid, organic acid or fatty acid oxidation disorders. A panel of disorders can be analyzed at high speeds. The methods and kits are particularly useful for newborn screening (NBS) of metabolic disorders.

### CROSS REFERENCE TO RELATED APPLICATIONS

This application claims priority from U.S. Provisional Patent Application Ser. No. 61/025,052 filed Jan. 31, 2008, the contents of which are incorporated herein by reference.

The section headings used herein are for organizational purposes only and are not to be construed as limiting the subject matter described in any way.

### FIELD OF THE INVENTION

The invention relates to methods and kits for detection of metabolic disorders in a sample.

### BACKGROUND OF THE INVENTION

Screening for biological disorders, in particular newborn screening (NBS) for these disorders, is currently performed using a variety of methods depending on the particular disorder screen. Amino acid and acylcarnitine analysis for NBS is currently performed by some practitioners using electrospray ionization coupled with tandem mass spectrometry (ESI-MS/MS). Liquid chromatography coupled with mass spectrometry has also been used for NBS, particularly for some organic acid analyses. The applicant's teachings provide a means to analyze a number of metabolic disorders, such as amino acid disorders, fatty acid oxidation disorders, and organic acid disorders, particularly the analysis of inborn errors of metabolism, at a significantly higher speed of analysis than the methods typically practiced at the present time.

### BRIEF SUMMARY OF THE INVENTION

These and other features of the applicant's teachings are set forth herein.

An aspect of the invention is to provide a method for analyzing a biological sample for a metabolic disorder, comprising: a) providing the biological sample and b) analyzing the sample by a laser desorption ion source coupled to a mass analyzer. The step of analyzing can comprise matrix assisted laser desorption ionization (MALDI) mass spectrometry. The method can further comprise collisionally damping/cooling the ions generated by the ion source with a damping gas. The step of collisionally damping/cooling can be orthogonal MALDI (oMALDI). The metabolic disorder can be a newborn metabolic disorder. The metabolic disorder can be selected from the group consisting of amino acid disorder, fatty acid oxidation disorder, and organic acid disorder. The disorder can be selected from the group consisting of phenylketonuria (PKU), hyperphenylalaninemias, maple syrup urine disease (MSUD), homocystinuria, citrullinemia (types I and II), argininemia, argininosuccinic acidemia (ASA), tyrosinemia (types I and II), homocitrullinuria, hyperornithinemia, hyperammonemia (HHH), methionine adenosyltransferase (MAT) deficiency, biopterin deficiencies, prolinemia, hypermethioninemia, gyrate atrophy of choroid and retina, medium chain acyl-CoA dehydrogenase (MCAD) deficiency, very long chain acyl-CoA dehydrogenase (VLCAD) deficiency, short chain acyl-CoA dehydrogenase (SCAD) deficiency, multiple acyl-CoA dehydrogenase (MAD) deficiency, long chain 3-hydroxyacyl-CoA dehydrogenase (LCHAD) deficiency, medium/short chain L-3-hydroxyacyl-CoA dehydrogenase (M/SCHAD) deficiency, trifunctional protein deficiency (TFP), carnitine palmitoyltransferase deficiencies of types I and II (CPT-I, CPT-II), carnitine-acylcarnitine translocase (CACT) deficiency, carnitine transporter deficiency, carnitine uptake defect, short chain 3-ketoacyl-CoA thiolase (SKAT) deficiency, medium chain 3-ketoacyl-CoA thiolase (MCKAT) deficiency, 2,4-dienoyl-CoA reductase deficiency, glutaric acidemia type II (GA-II), 3-methylcrotonyl-CoA carboxylase (3-MCC) deficiency, glutaric acidemia type I (GA-I), methylmalonic acidemias (MMA), propionic acidemia (PA), isovaleric acidemia (IVA), malonic aciduria (MA), multiple carboxylase deficiency (MCD), 2-methyl-3-hydroxybutyrl-CoA Dehydrogenase (MHBD) deficiency, 3-hydroxy-3-methylglutaryl-CoA lyase (HMG) deficiency, 2-methylbutyryl-CoA dehydrogenase (2MBCD) deficiency, 3-methylglutaconic acidurias (MGA), isobutyryl-CoA dehydrogenase (IBD) deficiency, beta-ketothiolase deficiency (BKT), and ethylmalonic encephalopathy (EE), among others.

In the methods described above, the step of providing the biological sample can comprise derivatizing the sample and spotting on a target surface. Derivatizing the sample can comprise derivatization to butyl esteric form. The step of providing the biological sample can comprise mixing the biological sample approximately 1:1 with CHCA.

In the methods described above, the biological sample can be an underivatized amino acid or acylcarnitine and step (a) can comprise (i) mixing the underivatized sample with UV substance and (ii) spotting the underivatized sample on a target surface.

In the methods described above, the step of analyzing the sample can comprise a tandem mass spectrometer, a triple quadrupole mass analyzer or an ion trap mass spectrometer. The method can further comprise multiple reaction monitoring. The method can further comprise a step of liquid chromatography prior to analyzing the sample by mass spectrometry. Further, the biological sample can be chosen from whole blood, blood components, frozen blood, blood spots, serum, plasma, physiological fluid, physiological tissue, inner cheek swabs, hair, cerebral spinal fluid, vitreous humor, or amniotic fluid, or others. Finally, the step of analyzing can comprise analysis in the positive ion mode or the negative ion mode.

In the methods described above, the step of analyzing the sample can comprise analysis of a panel of biological samples. The analysis can be done by a discrete mode of operation, a rastering mode of operation, or by a pattern raster mode of operation. Further, the step of providing the biological sample can comprise spotting the biological sample on a target surface to produce a panel of biological samples, and wherein at least one spot comprises a biological sample that is analyzed for at least two biological disorders simultaneously.

Another aspect of the invention is to provide a method for multiplexed analysis of a panel of biological samples for biological disorders comprising: (a) providing the panel of biological samples; (b) spotting the panel of biological samples on a target surface; and (c) analyzing the panel of biological samples by a laser desorption ion source coupled to a mass analyzer.

Another aspect of the invention is to provide a kit for the analysis of a metabolic disorder, comprising one or more of: (i) reagents for collection, preparation and/or analysis of biological samples comprising or suspected of comprising analytes of metabolic disorders for analysis by laser desorption ion source coupled to a mass analyzer; and (ii) instructions for the collection, preparation and/or analysis of samples for analysis by laser desorption ion source coupled to a mass analyzer. The metabolic disorder can be a newborn metabolic disorder. Further, the kit can be used for the analysis of a panel of metabolic disorders.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1 is a mass spectrum for precursor ions of 85.1 Da, showing exemplary data for the signal for derivatized acylcarnitines.

FIG. 2 is a mass spectrum for neutral loss of 102.0 Da, showing exemplary data for the signal for derivatized amino acids.

FIG. 3 is an exemplary MRM mass spectrum of the signal for derivatized free carnitine (C0), acetylcarnitine (C2), and stearoylcarnitine (C18).

FIG. 4 is an exemplary MRM mass spectrum of the signal for derivatized amino acids phenylalanine (Phe) and tyrosine (Tyr).

FIG. 5 is an exemplary MRM mass spectrum of the signal for non-derivatized internal standards for free carnitine (C0-D9), butyrylcarnitine (C4-D3), and palmitoylcarnitine (C16-D3).

FIG. 6 is an exemplary MRM mass spectrum of the signal for hexanoylcarnitine (C6) and its internal standard (C6-D3), using a product mass of 141.1 Da.

FIG. 7 is an exemplary MRM mass spectrum of the signal for non-derivatized amino acid tryptophan.

FIG. 8 is a chart showing exemplary acylcarnitine concentrations measured from dried blood spots (DBS).

FIG. 9 is a chart showing exemplary reproducibilities of acylcarnitine concentration measurements from dried blood spots.

FIG. 10 is a chart showing exemplary amino acid concentrations measured from dried blood spots.

FIG. 11 is a chart showing exemplary reproducibilities of amino acid concentration measurements from dried blood spots.

FIG. 12 is an exemplary mass spectrum showing relative intensities of MRM measurements for 19 acylcarnitine ion pairs from a dried blood spot. * indicates isotopically labeled internal standards.

FIG. 13 is a mass spectrum of the signal for isoleucine (Ile) butyl ester multiple reaction monitoring (MRM) transition ion (188.0→86.2). Each peak was obtained using a different laser power.

FIG. 14 is a mass spectrum of the signal for hexanoylcarnitine (C6) butyl ester MRM transition ion (316.0→85.0). Each peak was obtained using a different laser power.

FIG. 15 is a mass spectrum of the signal for acetylcarnitine (C2) butyl ester MRM transition ion (218.0→85.0). Each peak was obtained using a different laser power.

FIG. 16 is a mass spectrum of the signal for acetylcarnitine (C2) butyl ester MRM transition ion (218.0→103.0). Each peak was obtained using a different laser power.

FIG. 17 is a mass spectrum of the signal for arginine (Arg) butyl ester MRM transition ion (231.1→69.9). Each peak was obtained using a different laser power.

FIG. 18 is a mass spectrum of the signal for octanoylcarnitine (C8) butyl ester MRM transition ion (344.1→85.0). Each peak was obtained using a different laser power.

FIG. 19 is a mass spectrum of the signal for citrulline (Cit) butyl ester MRM transition ion (232.1→113.1). Each peak was obtained using a different laser power.

FIG. 20 is a mass spectrum of the signal for methionine (Met) butyl ester MRM transition ion (206.1→103.9). Each peak was obtained using a different laser power.

FIG. 21 is a mass spectrum of the signal for ornithine (Orn) butyl ester MRM transition ion (189.2→69.9). Each peak was obtained using a different laser power.

FIG. 22 is a mass spectrum of the signal for phenylalanine (Phe) butyl ester MRM transition ion (222.1→120.0). Each peak was obtained using a different laser power.

FIG. 23 is a mass spectrum of the signal for tyrosine (Tyr) butyl ester MRM transition ion (238.0→136.1). Each peak was obtained using a different laser power.

FIG. 24 is a mass spectrum of the signal for valine (Val) butyl ester MRM transition ion (174.1→72.0). Each peak was obtained using a different laser power.

FIG. 25 is a mass spectrum of the signal for deuterated free carnitine (C0), multiple reaction monitoring (MRM) transition ion (171.2→103.1). Sets of 4 peaks are representative of different analyte concentrations.

FIG. 26 is a mass spectrum of the signal for deuterated acetylcarnitine (C2), multiple reaction monitoring (MRM) transition ion (207.2→85.0). Sets of 4 peaks are representative of different analyte concentrations.

FIG. 27 is a mass spectrum of the signal for deuterated propionylcarnitine (C3), multiple reaction monitoring (MRM) transition ion (221.2→85.0). Sets of 4 peaks are representative of different analyte concentrations.

FIG. 28 is a mass spectrum of the signal for deuterated butyrylcarnitine (C4), multiple reaction monitoring (MRM) transition ion (235.3→85.0). Sets of 4 peaks are representative of different analyte concentrations.

FIG. 29 is a mass spectrum of the signal for deuterated isovalerylcarnitine (C5), multiple reaction monitoring (MRM) transition ion (255.3→85.0). Sets of 4 peaks are representative of different analyte concentrations.

FIG. 30 is a mass spectrum of the signal for deuterated octanoylcarnitine (C8), multiple reaction monitoring (MRM) transition ion (291.3→85.0). Sets of 4 peaks are representative of different analyte concentrations.

FIG. 31 is a mass spectrum of the signal for deuterated myristoylcarnitine (C14), multiple reaction monitoring (MRM) transition ion (381.3→85.0). Sets of 4 peaks are representative of different analyte concentrations.

FIG. 32 is a mass spectrum of the signal for deuterated palmitoylcarnitine (C16), multiple reaction monitoring (MRM) transition ion (403.3→85.0). Sets of 4 peaks are representative of different analyte concentrations.

FIG. 33 is a mass spectrum of the signal for asparagine (Asn), multiple reaction monitoring (MRM) transition ion (133.2→73.8). The first peak is due to analyte, the second peak is due to MALDI matrix background.

FIG. 34 is a mass spectrum of the signal for histidine (His), multiple reaction monitoring (MRM) transition ion (156.2→110.4). The first peak is due to analyte, the second peak is due to MALDI matrix background.

FIG. 35 is a mass spectrum of the signal for proline (Pro), multiple reaction monitoring (MRM) transition ion (116.2→70.2). The first peak is due to analyte, the second peak is due to MALDI matrix background.

FIG. 36 is a mass spectrum of the signal for serine (Ser), multiple reaction monitoring (MRM) transition ion (106.0→60.4). The first peak is due to analyte, the second peak is due to MALDI matrix background.

FIG. 37 is a mass spectrum of the signal for threonine (Thr), multiple reaction monitoring (MRM) transition ion (120.4→74.2). The first peak is due to analyte, the second peak is due to MALDI matrix background.

FIG. 38 is a mass spectrum of the signal for tryptophan (Trp), multiple reaction monitoring (MRM) transition ion (205.4→188.2). The first peak is due to analyte, the second peak is due to MALDI matrix background.

### DETAILED DESCRIPTION OF VARIOUS EMBODIMENTS

While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

In recent years there have been numerous reports regarding the advantages of using mass spectrometry to perform newborn screening, particularly for inborn errors of metabolism. The two principal scan functions currently used for NBS by electrospray triple quadrupole mass spectrometry are precursor ion scans and neutral loss scans. These scan modes are typically employed in order to take advantage of the common chemistries presented with certain classes of compounds, or to take advantage of particular sample preparation techniques. With these two scan modes the mass spectrometer is set to scan over particular mass ranges, with the speed of analysis being constrained by the scanning speed of the triple quadrupole mass spectrometer, resulting in limited sample throughput. Practitioners of NBS are required to balance speed of analysis with data quality and quality of results, and scanning too fast can compromise the quality of data and results. More recently, a limited number of practitioners of NBS have employed the multiple reaction monitoring (MRM) mode of operation of triple quadrupole mass spectrometers to perform fast analysis for a number of disease states, particularly for biological disorders, such as metabolic disorders. These practitioners also employed other triple quadrupole modes of operation, such as product ion scans, neutral loss scans, precursor ion scans, and single quadrupole scans in their method development and for further disease elucidation in addition to the quantitative or semi-quantitative measurements provided by the MRM mode of operation.

The applicant's teachings comprise the analysis for metabolic disorders, including, but not limited to, amino acid disorders, fatty acid oxidation disorders, and organic acid disorders, by using a laser desorption ion source coupled to a mass analyzer. For example, the laser desorption ion source that is coupled to a mass analyzer can comprise matrix-assisted laser desorption ionization (MALDI) coupled with a triple quadrupole mass analyzer, particularly with the MRM mode of operation of such a mass analyzer to provide quantitative or semi-quantitative analysis. Alternatively, the laser desorption ion source that is coupled to a mass spectrometer can comprise any target surfaces that have been specifically designed to eliminate the need for MALDI matrix yet still provide adequate desorption and ionization of analytes from the surface. The applicant's teachings can be particularly useful in newborn screening for metabolic disorders, such as amino acid disorders, fatty acid oxidation disorders, and organic acid disorders. In the NBS case, such analyses can be for pre-emptive purposes or for diagnostic purposes for specific disease states. Analyses can be accomplished through detection and quantification of specific analytes indicative of specific metabolic disorders, such as amino acid disorders, fatty acid oxidation disorders, and organic acid disorders.

As is known to those skilled in the art, metabolic disorders can include, but are not limited to, amino acid disorders, fatty acid oxidation (FAO) disorders, and organic acid disorders. Amino acid disorders can include, for example but are not limited to, phenylketonuria (PKU) and other hyperphenylalaninemias, maple syrup urine disease (MSUD), homocystinuria, citrullinemia (types I and II), argininemia, argininosuccinic aciduria (ASA), tyrosinemia (types I and II), homocitrullinuria, hyperornithinemia, hyperammonemia (HHH), methionine adenosyltransferase (MAT) deficiency, biopterin deficiencies, prolinemia, hypermethioninemia, and gyrate atrophy of choroid and retina. Screening for amino acid disorders by MS/MS usually involves making quantitative or semi-quantitative measurements on amino acids.

As is known to those skilled in the art, FAO disorders can include, for example but are not limited to, medium chain acyl-CoA dehydrogenase (MCAD) deficiency, very long chain acyl-CoA dehydrogenase (VLCAD) deficiency, short chain acyl-CoA dehydrogenase (SCAD) deficiency, multiple acyl-CoA dehydrogenase (MAD) deficiency, long chain 3-hydroxyacyl-CoA dehydrogenase (LCHAD) deficiency, medium/short chain L-3-hydroxyacyl-CoA dehydrogenase (M/SCHAD) deficiency, trifunctional protein deficiency (TFP), carnitine palmitoyltransferase deficiencies of types I and II (CPT-I, CPT-II), carnitine-acylcarnitine translocase (CACT) deficiency, carnitine transporter deficiency, carnitine uptake defect, short chain 3-ketoacyl-CoA thiolase (SKAT) deficiency, medium chain 3-ketoacyl-CoA thiolase (MCKAT) deficiency, 2,4-dienoyl-CoA reductase deficiency, and glutaric acidemia type II (GA-II). Screening for fatty acid disorders by MS/MS usually involves making quantitative or semi-quantitative measurements on acylcarnitines. Free carnitine is not an acylcarnitine, but as those skilled in the art will understand, use of the term “acylcarnitines”, in the context of making measurements for the purpose of NBS, often includes free carnitine along with true acylcarnitines. Such is the case in this discussion.

As is known to those skilled in the art, organic acid disorders can include, for example but are not limited to, 3-methylcrotonyl-CoA carboxylase (3-MCC) deficiency, glutaric acidemia type I (GA-I), methylmalonic acidemias (MMA), propionic acidemia (PA), isovaleric acidemia (IVA), malonic aciduria (MA), multiple carboxylase deficiency (MCD), 2-methyl-3-hydroxybutyrl-CoA Dehydrogenase (MHBD) deficiency, 3-hydroxy-3-methylglutaryl-CoA lyase (HMG) deficiency, 2-methylbutyryl-CoA dehydrogenase (2 MBCD) deficiency, 3-methylglutaconic acidurias (MGA), isobutyryl-CoA dehydrogenase (IBD) deficiency, beta-ketothiolase deficiency (BKT), and ethylmalonic encephalopathy (EE).

The applicant's teachings comprise high throughput quantification of biomarkers through the use of laser desorption of samples on a target plate (for example, a MALDI plate), followed by mass spectrometric analysis. MALDI is an ionization technique in which samples are combined with a MALDI matrix (a UV light absorbing compound), deposited in specific locations on a target surface, and then desorbed and ionized by a series of laser pulses, forming an ablation plume. In the MALDI case, the ablation plume is comprised of particles from the sample, including analytes of interest, and particles from the MALDI matrix. The ablation plume, or part of it, is then subjected to mass spectrometric analysis. Examples of some commonly used MALDI matrices are: α-cyano-4-hydroxycinnamic acid (often referred to as α-CHCA or CHCA); 2,5-dihydroxybenzoic acid (DHB), and 3,5-dimethoxy-4-hydroxycinnamic acid (sinapinic acid). Other MALDI matrices can be used and are included within the scope of the invention. In the case where the laser desorption ion source that is coupled to a mass spectrometer comprises target surfaces that have been specifically designed to eliminate the need for MALDI matrix, the samples are similarly deposited in specific locations on the target surface and the series of laser pulses provide desorption and ionization with formation of an ablation plume. In this case the ablation plume is comprised of particles from the sample, including analytes of interest, and can include particles liberated from the target surface. This MALDI matrix-less ablation plume, or part of it, is then subjected to mass spectrometric analysis.

The method can involve the use of a damping gas to collisionally cool the analyte ions in the MALDI plume. For example, the method can involve Orthogonal MALDI, or “oMALDI™” (trademark of Applied Biosystems/MDS Sciex), which was introduced by a group at the University of Manitoba and is described in U.S. Pat. No. 6,331,702. oMALDI is a technique that decouples the laser ablation process from the mass spectrometric detection process, which is a different approach than the high-coupling approach typically used in MALDI-TOF instruments. In oMALDI, the laser ablation generates a plume of ions that is collisionally cooled in a region of relatively high pressure within a radio frequency (RF) ion guide. Through collisions with the damping gas in this region, the pulses of ions generated from the pulses of laser light impinging on the sample are converted into a quasi-continuous ion beam. This ion beam is directed into the mass spectrometer, where it is analyzed by any one of a number of “scan modes”. The scan mode that most readily enables quantification of targeted ions is MRM.

The system can include the MRM mode of operation of a triple quadrupole (tandem) mass analyzer. In MRM mode of operation, the first mass analyzing quadrupole is set to select a specific “precursor” ion from the ions passing through the first mass analyzing quadrupole, a second non-mass analyzing quadrupole is used to cause controlled dissociation of the precursor ion, and the third quadrupole (the second mass analyzing quadrupole) is set to select only a specific fragment, or “product”, ion of the precursor ion. The precursor and product combination is referred to as the MRM ion pair.

In this teaching, MRM data can be acquired in several different manners, with the differences being in how the laser is allowed to interact with the sample on the target plate, for example, depending on the ablation mode that is used. A “raster” ablation mode involves the laser beam cutting a straight line swath across one or more samples. To accomplish this “rastering” the laser beam is fired at a non-sample location prior to a sample spot of interest, and the target plate can then be moved continuously to present new samples to the laser impingement point. This means that the laser desorption point will encounter an alternating series of sample/no sample sections of the target plate. The resulting MRM data contains a series of ion signal “peaks”, indicated by ion counts per second as a function of mass spectrometer analysis time, with non-zero signal where sample was encountered, interspersed with regions of zero-signal baseline in between sample spots. Depending on laser power, speed of target plate movement under the laser beam, number of analytes being monitored, and sample composition, it can be typical to acquire the data for a single sample (monitoring one, or several, MRM ion pairs) in approximately 0.25 to 5 seconds for this mode of ablation.

In a “discrete” mode of operation, with the laser in a non-firing state the target plate can be positioned under the laser impingement point and the laser can then be turned on for some specific period of time. While the laser is not firing, the mass spectrometer records a signal of zero (since no ions are generated). When the laser commences firing the laser beam desorbs material from this specific location, creating an MRM signal “peak”. The MRM signal intensity rises from zero and quickly maximizes, and it then decreases as the sample is depleted from that specific location on the target plate. The MRM signal level returns to the zero baseline level either by turning off the laser, or by permitting the laser to fire until the sample is completely consumed from the particular location and there is no more sample from which to generate ions. After the laser firing is stopped, the sample plate can then be moved so as to present a new sample location for the next ablation. Depending on laser power, sample composition, and the length of time the laser is fired, it can be typical to acquire the data for a single sample in well under one second for this mode of ablation.

Other ablation modes involve the movement of a sample spot according to some pattern, such that the continually firing laser generates a pattern across the sample spot. This “pattern raster” mode generates a steady stream of ions from a few seconds to several minutes, depending on the form and speed of the pattern within the sample spot. One or more sample spots can be included in such a mode, with proper accommodation when moving from one sample spot to the next. The mass spectrometer method can be constructed to perform a number of different measurements, even including the mixing of mass spectrometer scan types. Pattern rasters are useful for measurements which require ablation times longer than those typically used for MRM analyses with this technique (e.g. precursor or neutral loss scans).

The applicant's teachings provides an extremely fast rate of sample analysis compared to standard tandem mass spectrometry methods for this application, providing a much more powerful technique than the prior art mass spectrometric methods used for detecting metabolic disorders. This increase in speed of analysis for disorders screened for by MS/MS can be used to permit screening for a larger number of biomarkers in the same, or shorter, time frame than prior art and other state of the art time frames. The speed of the applicant's method also permits an extremely fast “first pass” screen for particular biomarkers. If any one of a set of biomarkers is detected at a level signifying a possible disorder, then a more detailed and specific screen can be performed. This, again, increases the number of biomarkers that can be used in comparison to the current MS/MS newborn screening panels. Another advantage of the applicant's teaching is that the samples are “frozen” on the sample plate, meaning that after the liquid sample depositions crystallize on the sample plate the samples exist in a solid form and can therefore be analyzed at any time, and with a variety of procedures, providing the ability to immediately perform the more detailed screening on the same biological sample. The “frozen” aspect of the samples on the sample plate can also provide for convenient on-plate storage and shipment of the samples. In addition to an unprecedented speed of analysis for screening for metabolic disorders such as amino acid disorders, fatty acid oxidation disorders, and organic acid disorders, the MALDI-MRM method consumes only very small amounts of sample. Sample deposition volumes onto the target plate are typically on the order of 1 μl, and multiple single raster passes can be made across the same dried sample spots, with each pass adjacent to previous passes. This means that once the sample has been deposited on the plate (for example, a MALDI plate), it is “frozen” in place and can therefore be rerun, depending on the results obtained for any other measurement associated with the particular sample. Alternatively, because of the low sample volume required to form a sample spot on the target plate, the same biological sample can be spotted several times on the plate, with different analyses performed on the different sample locations.

The sample is the substance containing or suspected of containing an analyte. The sample can be any sample capable of being analyzed by the methods described herein, for example the sample can be, but is not limited to blood, serum, plasma, or urine.

As stated above, the biological sample can be any biological sample, for example it can be a dried blood spot (DBS) from the heel prick of a newborn. As is known to those skilled in the art, the biological sample can also be, but is not limited to, whole blood, or blood components (for example serum or plasma). Other biological samples generally termed ““physiological fluid & tissue”, can comprise more specifically inner cheek swabs, hair, cerebral spinal fluid, vitreous humor, amniotic fluid, frozen blood, or dried blood spots (DBS), to name a few.

### EXAMPLES

Aspects of the applicant's teachings can be further understood in light of the following examples, which should not be construed as limiting the scope of the applicant's teachings in any way.

### Example 1

### A Chromsystems™ (Germany) Newborn Screening Kit and a Number of Commercially Available Acylcarnitines and Amino Acids have been Used to Demonstrate the Utility of the MALDI-MRM Method for Making Novel Measurements Applicable to High Throughput Screening for Biological Disorders

The Chromsystems™ NBS Kit contains 13 acylcarnitines, 12 amino acids, and isotopically labeled (deuterated) internal standards for each of these. The 13 acylcarnitines in the kit are free carnitine (C0), acetylcarnitine (C2), propionylcarnitine (C3), butyrylcarnitine (C4), isovalerylcarnitine (C5), hexanoylcarnitine (C6), octanoylcarnitine (C8), decanoylcarnitine (C10), glutarylcarnitine (C5DC), dodecanoylcarnitine (C12), myristoylcarnitine (C14), palmitoylcarnitine (C16), and stearoylcarnitine (C18). The abbreviations, or symbols, for acylcarnitines are generally derived from the length of their carbon-containing alkyl chains. The 12 amino acids in the kit are phenylalanine (Phe), tyrosine (Tyr), leucine (Leu), arginine (Arg), citrulline (Cit), glutamic acid (Glu), ornithine (Orn), methionine (Met), valine (Val), aspartic acid (Asp), alanine (Ala), and glycine (Gly). The Chromsystems™ Tuning Kit, supplied with the Chromsystems™ Newborn Screening Kit, contains the 13 acylcarnitines, 12 amino acids, and deuterated internal standards for each of these, with each of these compounds having been derivatized to a butyric ester form. Butylated acylcarnitines and many butylated amino acids have masses 56 Da higher than their non-derivatized counterparts. The butylated forms of aspartic acid and glutamic acid contain two acid groups, increasing the masses for their derivatized forms by 112 Da compared to their non-derivatized counterparts.

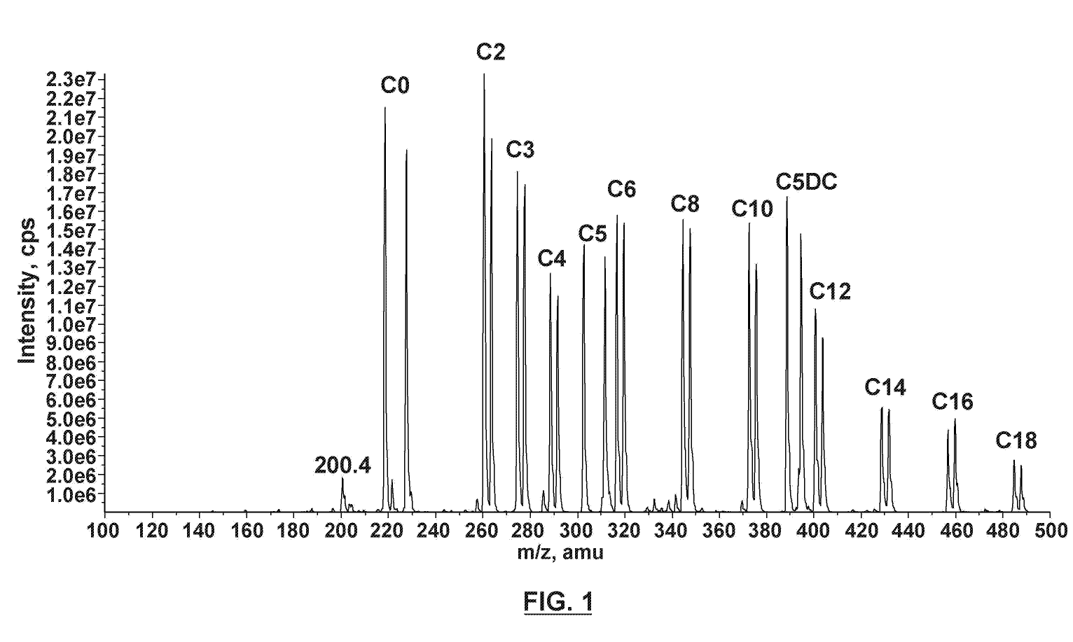

Referring to the drawings, FIG. 1 shows a triple quadrupole mass spectrum for precursor ions of 85.1 Da. A triple quadrupole mass spectrometer was used throughout Example 1. This is the scan type typically used by NBS practitioners for detection and quantitation or semi-quantitation of acylcarnitines in newborn screening by mass spectrometry. The spectrum shows two peaks beneath each acylcarnitine label, the first being the acylcarnitine analyte and the second being its deuterated internal standard, a few Daltons higher. The MALDI sample spot contained an aliquot from the Tuning Mix supplied with the Chromsystems™ kit. This Tuning Mix contains concentrations somewhat higher than biologically endogenous levels of the 13 acylcarnitines and 12 amino acids. All of the butylated acylcarnitines produce a characteristic fragment ion of mass 85 Da when subjected to properly controlled dissociation in the collision cell of the tandem mass spectrometer. To produce this spectrum, the MALDI plate was moved under the high repetition rate laser (1000 Hz) ablation point so as to perform a pattern raster over the sample spot to provide continuous supply of fresh sample for ablation by the laser beam. The second mass analyzing quadrupole was set to pass only ions of mass 85.1 Da, while scanning the first analyzing quadrupole across the mass range to indicate which precursor ion masses produced the 85.1 Da fragments.

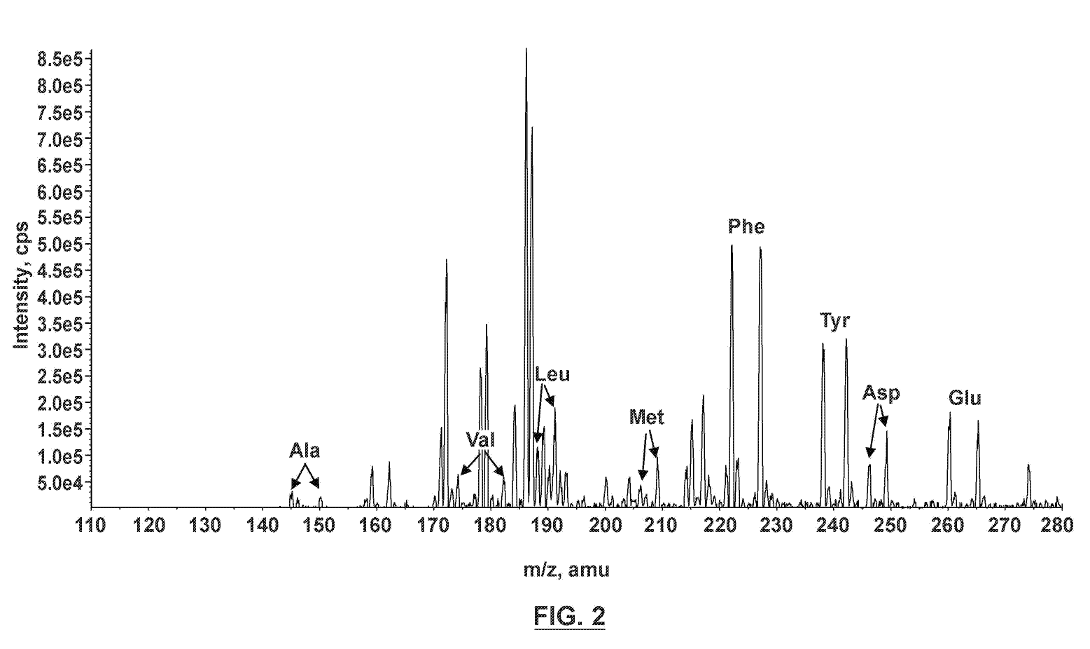

FIG. 2, also acquired from a MALDI sample spot containing an aliquot from the Chromsystems™ Tuning Mix, shows a mass spectrum for neutral loss of 102.0 Da. This is the scan type typically used by NBS practitioners for detection and quantitation or semi-quantitation of several amino acids in newborn screening by mass spectrometry. The spectrum shows two peaks beneath each of the 8 amino acid labels, the first being the amino acid and the second being its deuterated internal standard, a few Daltons higher. To produce this spectrum the two analyzing quadrupoles of the tandem mass spectrometer were locked 102.0 Da apart and were then both scanned over the mass range, and the laser was commanded to perform a pattern raster over one sample spot.

The amino acid peaks arise from dissociative loss of butyl formate in the mass spectrometer collision cell. Four of the amino acids in the Chromsystems™ kit were not measured by neutral loss of 102 scans on the tandem mass spectrometer due to molecular fragmentation patterns that did not include loss of a neutral fragment of 102 Da. Upon fragmentation, ornithine and citrulline lose ammonia as well as the butyl formate fragment, for a total loss of 119 Da. Glycine fragments via a loss of 56 Da (butene), and arginine is usually monitored by a loss of fragments of 56 or 161 Da. As is known to those skilled in the art, MRM is usually employed for quantification of these analytes. There are other peaks in the neutral loss spectrum, which are not associated with the analytes of interest. The same is true for the precursor ion scan for acylcarnitine analysis. In comparison to the amino acids, the acylcarnitines ionize very efficiently by MALDI, producing signals that dominate the spectrum for the high concentrations in the Tuning Mix, therefore the other peaks are not obvious for the scale shown in FIG. 1.

With MALDI-MS-MS, screening can be performed by use of neutral loss scans and precursor ion scans, but the speed of analysis is slower and the quantitative or semi-quantitative measurement of analytes of interest is of lower quality than with the use of MRM. Neutral loss and precursor ions scans require significant time to scan across mass ranges, and additional time to repeat these scans enough times to obtain spectra which provide high quality quantitation or semi-quantitation results. The time required for these scan types necessitates time consuming pattern rasters for sample ablation. Neutral loss scans and precursor ion scans can provide highly useful qualitative “snapshots” of the entire profile of analytes of interest that can be detected with the particular scan function in use. However, the selectivity and specificity of MRM can provide the ability to isolate distinguishable fragment ions originating from ions of interest from interferences of biological natures and from potential MALDI matrix interferences. That is, MRM scans can be used to “zero in” on particular analytes to perform high quality quantitative or semi-quantitative measurements for those analytes, providing fewer false positives and false negatives than the more qualitative approach of the other scan types. For quantitative or semi-quantitative measurements in such targeted analyses MRM scans can provide significant speed advantages.

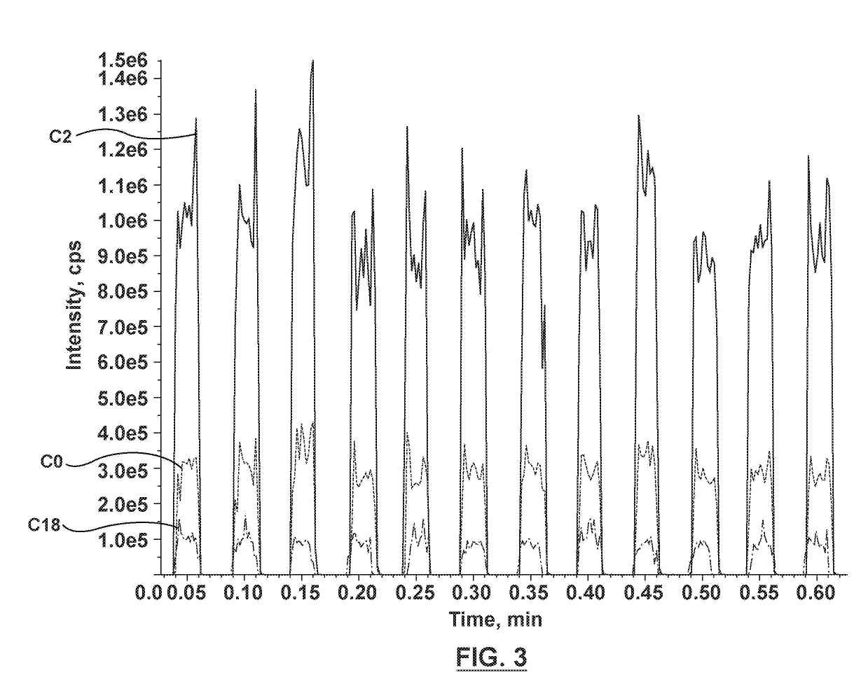

In newborn screening for inborn errors of metabolism a prick to the heel of the neonate is typically used to obtain a small sampling of blood onto a “filter paper”, or blood spot card, where it is allowed to dry to become a dried blood spot (DBS). Subsections of the DBS are punched out from the filter paper and are subjected to a sample preparation protocol which can comprise analyte extraction, and which can comprise addition of acylcarnitine and amino acid internal standards. This can be followed by derivatization. For example, the derivatization can be to butyl esters. The butyl esteric derivatization can improve the ionization of the compounds of interest for NBS measurements on acylcarnitines and amino acids, and it also provides a common MS-MS fragmentation mechanism, particularly for a number of amino acids. The blood volume on the punched out dried blood disk is variable, meaning that screening performed from dried blood spots is normally semi-quantitative rather than quantitative, as those skilled in the art can appreciate. FIG. 3 shows typical MRM data obtained for the measurement of three derivatized acylcarnitines from a DBS Control supplied with the Chromsystems™ kit. The mass spectrometer was set to record MRM ion pairs that included the common 85.1 Da fragment of acylcarnitines. The ion pairs corresponding to the MRM traces in the figure are 218.2/85.1 (free carnitine, C0), 260.2/85.1 (acetylcarnitine, C2), and 484.4/85.1 (stearoylcarnitine, C18). Data was acquired from 12 sample spots from the same DBS, with the laser firing at a rate of 1000 Hz and rastering across the sample spots at a rate of 1.5 mm/s. The mass spectrometer was set to measure 10 ion pairs: 5 acylcarnitines and their 5 internal standards, though for visual clarity only 3 ion pairs are shown in the figure. The laser power, the speed of the laser raster across the sample spots, and the MRM dwell time for each ion pair is adjusted to provide MRM signal peaks containing analytically acceptable numbers of data points for the particular measurement of interest. For the 10 MRM ion pairs in this illustration, an MRM dwell time of 7 milliseconds was used, and 12 samples were run in less than 40 seconds, for semi-quantitative analysis of 5 acylcarnitines. The individual MRM peaks, corresponding to one sample spot, are approximately 1.2 seconds wide, full width at half maximum. The previously described discrete ablation mode is suited to measuring 2 to 6 ion pairs, with MRM dwell times of 5-20 ms, and total single sample analysis time of several hundred milliseconds. The high repetition rate laser permits ablation rates and ion flux rates that permit this novel mass spectrometric speed of analysis.

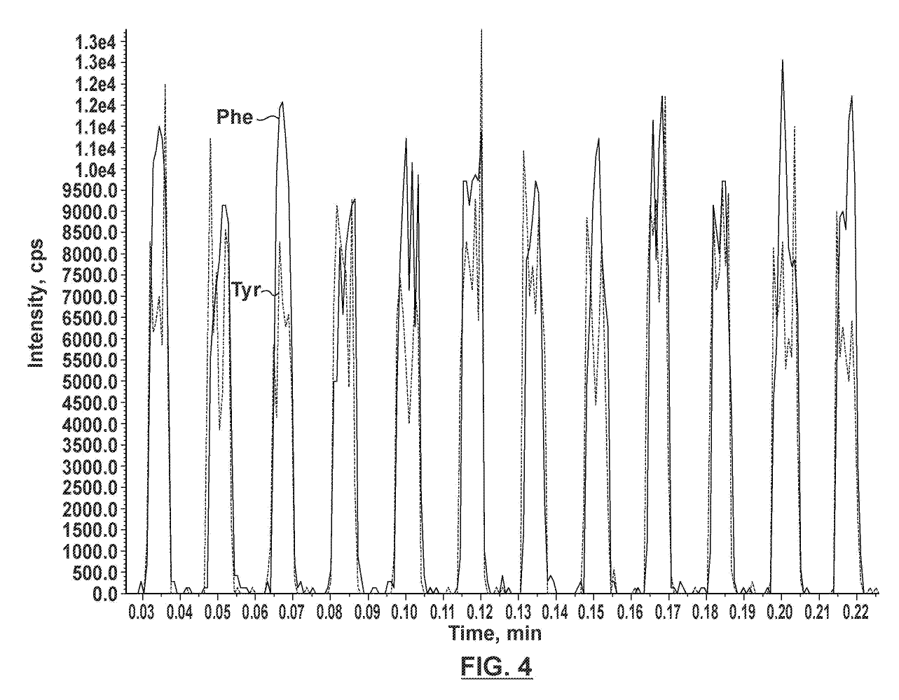

FIG. 4 shows typical MRM data obtained for the measurement of two derivatized amino acids from a DBS Control supplied with the Chromsystems™ kit. The ion pairs corresponding to the MRM traces in the figure are 222.1/120.0 (phenylalanine, Phe) and 238.3/136.1 (tyrosine, Tyr), which comprise the main analytes for screening for phenylketonuria (PKU). Data was acquired from 12 sample spots from the same DBS, with the laser firing at a rate of 1000 Hz and rastering across the sample spots at a rate of 4.5 mm/s. The mass spectrometer was set to measure 4 ion pairs: the two amino acids and their respective internal standards, though for visual clarity only two ion pairs are shown in the figure. For the 4 MRM ion pairs in this illustration, an MRM dwell time of 7 milliseconds was used, and 12 samples were run in approximately 12 seconds, for semi-quantitative analysis of two amino acids. The individual MRM peaks corresponding to single samples are approximately one third of a second wide, full width at half maximum.

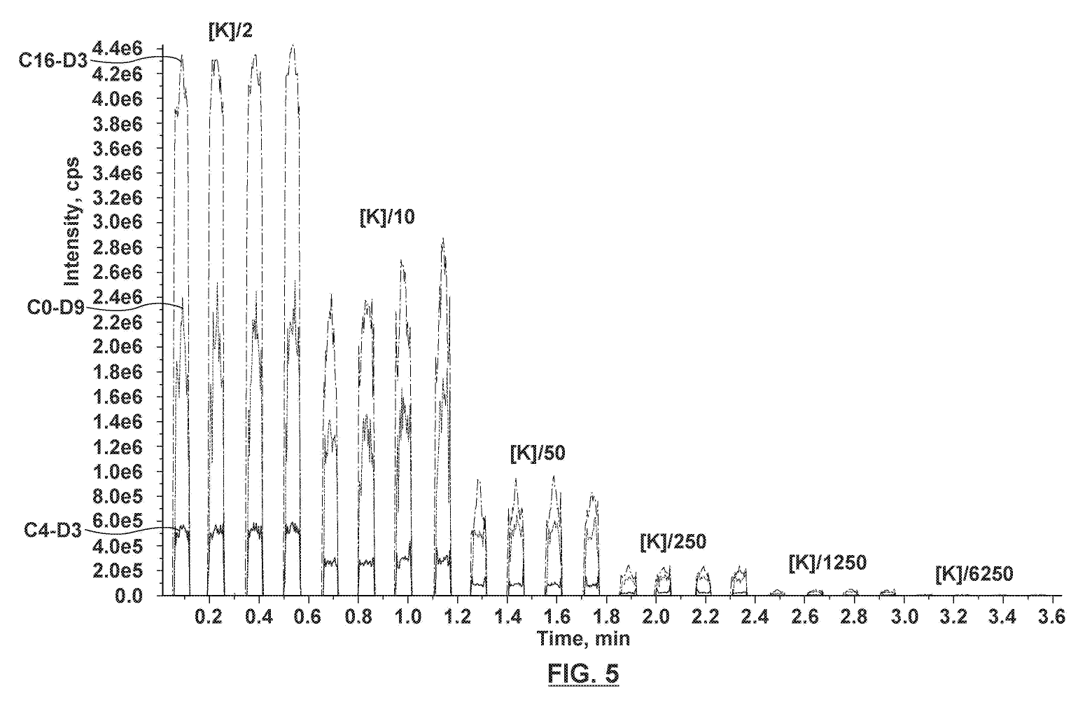

For newborn screening for inborn errors of metabolism it is not required to derivatize the analytes of interest to butyl esters. Recently, there have been an increasing number of reports of practitioners screening through use of non-derivatized acylcarnitines and amino acids. For non-derivatized acylcarnitines, MS-MS collision cell dissociation continues to provide the common 85 Da fragment ion, enabling continued use of the precursor of 85 Da mass spectrometer scan, or MRM can be used as an alternative. As mentioned previously many, but not all, amino acids derivatized to butyl esteric form provide a common MS-MS fragmentation pathway via loss of butyl formate (102 Da). Without derivatization there is not a common scan function to be employed for measurement of amino acids; in this case, MRM is usually used. FIG. 5 shows typical MRM data obtained for the measurement of 3 non-derivatized acylcarnitine internal standards, with ion pairs 171.2/103.1 (C0-D9 for free carnitine), 235.3/85.1 (C4-D3 for butyrylcarnitine), and 403.3/85.1 (C16-D3 for palmitoylcarnitine). The mass spectrometer was set to measure 8 MRM ion pairs, for the 8 non-derivatized acylcarnitine isotopically labeled (deuterated) standards included in the Cambridge Isotopes (Maryland, USA) Newborn Screening Kit, though for visual clarity only 3 ion pairs are shown in the figure. The other non-derivatized isotopically labeled acylcarnitines that were measured from the Cambridge Isotopes kits corresponded to acetylcarnitine (C2), propionylcarnitine (C3) isovalerylcarnitine (C5), hexanoylcarnitine (C6), and myristoylcarnitine (C14). “[K]” indicates the concentration produced by following the protocol of the instructions in the kit. A series of dilutions was made, for example, [K2]/2 means that the dilution was to one-half concentration, with aliquots for each concentration spotted on the target plate after mixing with MALDI matrix. Data was acquired from sets of 4 sample spots corresponding to varying concentrations of the standards on the target plate by rastering the laser at 0.5 mm/s and using 20 ms MRM dwell times, producing a standards curve. For free carnitine it was found that the 103 Da fragment produced a more intense ion signal and better detection limit than the usual 85 Da fragment. This freedom to choose particular product ions illustrates an advantage of the MRM approach compared to full scan approaches such as precursor scans.

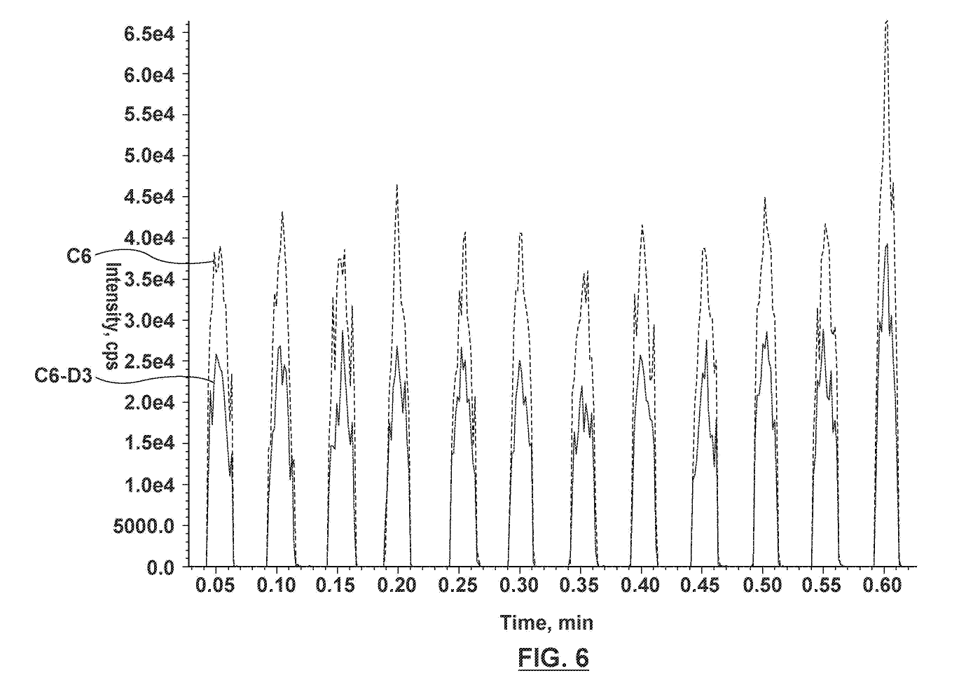

FIG. 6 shows typical MRM data obtained for the measurement of derivatized hexanoylcarnitine (C6) and its internal standard (C6-D3) from a DBS Control supplied with the Chromsystems™ kit. The mass spectrometer was set to record MRM ion pairs that corresponded to the 141.1 Da fragment rather than the usual 85 Da fragment. Although the 85 Da fragment provided significantly increased signal, increased background signal from the sample matrix and the MALDI matrix resulted in poorer signal-to-noise ratios, which in turn led to poorer analytical results. When using MRM for measurements, the system can be optimized for each analyte instead of operating under compromised conditions in order to accommodate a particular scan function of the mass spectrometer.

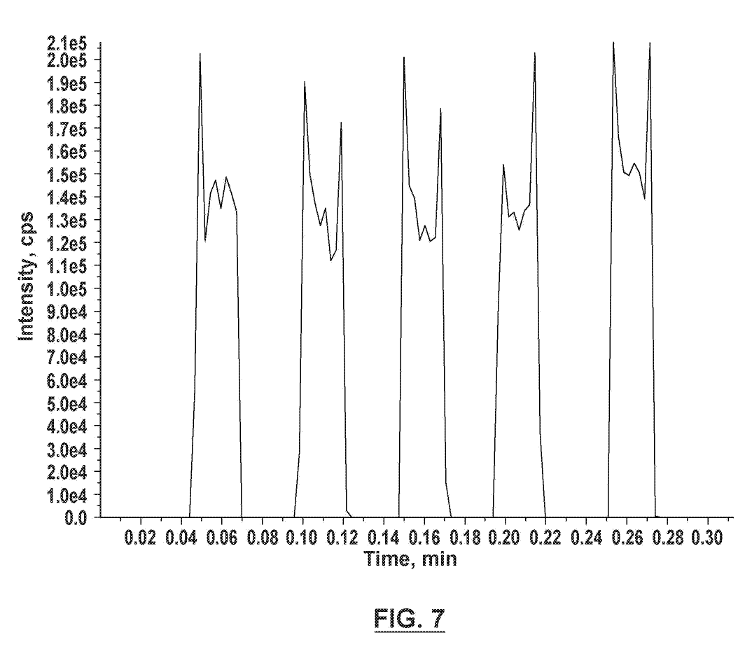

FIG. 7 shows typical MRM data for the non-derivatized amino acid, tryptophan (Trp). The non-derivatized amino acids that were investigated using the MALDI-MRM technique make up the 20 main amino acids and include phenylalanine (Phe), tyrosine (Tyr), leucine (Leu), arginine (Arg), glutamic acid (Glu), methionine (Met), valine (Val), aspartic acid (Asp), alanine (Ala), glycine (Gly), asparagine (Asn), cysteine (Cys), glutamine (Gln), histidine (His), isoleucine (Ile), lysine (Lys), proline (Pro), serine (Ser), threonine (Thr), and tryptophan (Trp).

The Dried Blood Spot Controls from the Chromsystems™ kit were provided with documentation indicating the concentrations of specific acylcarnitines and amino acids in the dried blood spots. According to the Chromsystems™ documentation, this enables the monitoring of the accuracy and precision of analytical procedures for the semi-quantitative determination of acylcarnitines and amino acids from dried blood. The dried blood spot controls were subjected to the entire sample preparation, including analyte extraction and derivatization, as though they were newborn screening patient samples. There were two set of DBS controls in the Chromsystems™ kit: Level I and Level II. Both sets of controls contained internal standards for acylcarnitines and amino acids, and the Level II control contained higher levels of analyte acylcarnitines and amino acids. Using the MALDI-MRM technique, for each dried blood spot the signals for the acylcarnitine analytes and the amino acid analytes were measured and the ratios to their respective internal standards were used to calculate the concentration of the analytes present in the dried blood spot controls, given the known concentrations of the internal standards.

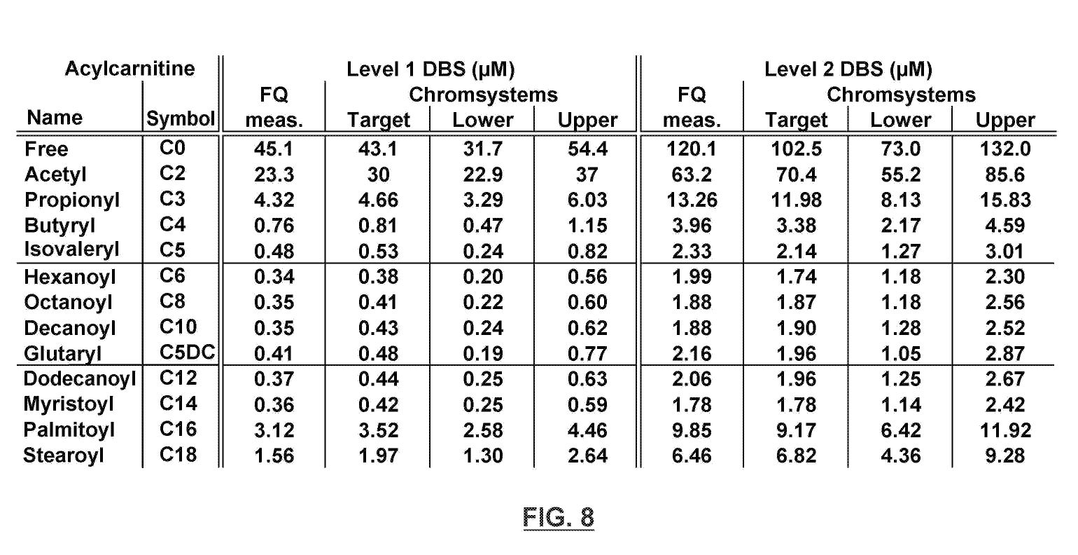

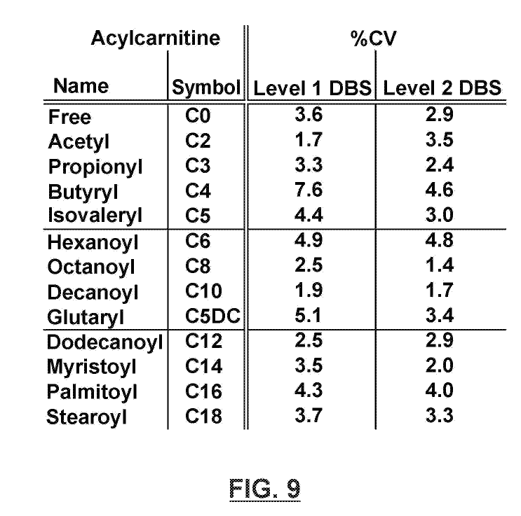

FIG. 8 shows the acylcarnitine concentrations measured from Chromsystems™ DBS Controls using the MALDI-MRM method. The table in FIG. 8 contains similar sections for Level I and Level II dried blood spots. In each of these sections, the column titled “FQ meas.” indicates the concentration measured using the MALDI-MRM method and the columns under the title “Chromsystems” indicate the mean expected values and the lower and upper limits of the acceptable range, as given by documentation in the Chromsystems™ kit. The concentrations measured using the MALDI-MRM technique were all within the acceptable range, and all were within 23% of the target value. The measured values in FIG. 8 were the average values of 12 identical measurements on sample spots from the same dried blood spots. FIG. 9 shows the good reproducibility of the 12 acylcarnitine MALDI-MRM measurements, as given by the % CV (standard deviation times 100 divided by the average value).

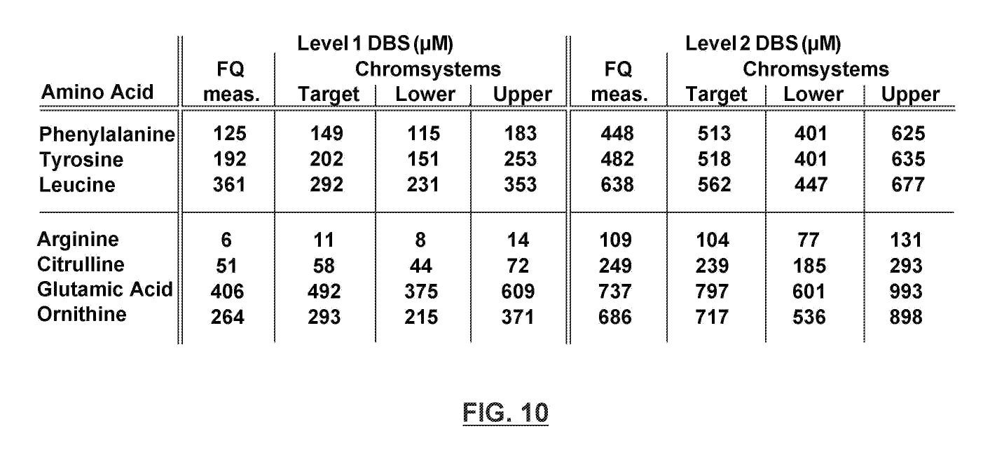

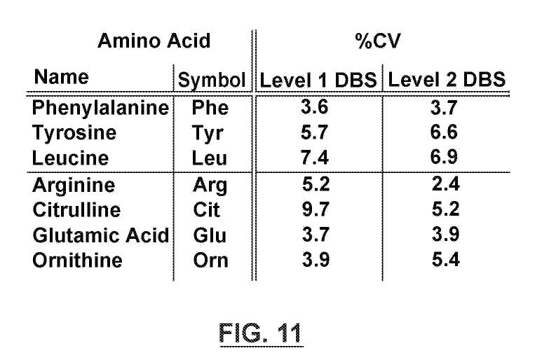

FIG. 10 shows the amino acid concentrations measured from Chromsystems™ DBS Controls using the MALDI-MRM method. The table in FIG. 10 is of the same format as the table in FIG. 8, with columns having the same meaning. For the 7 amino acids shown in the table in FIG. 10 the measured concentrations were within the acceptable ranges for all analytes except leucine and arginine, which were both slightly outside the acceptable range for the Level I dried blood spot control. The concentrations measured for the other 5 amino acids in the kit were not within the acceptable range for the Chromsystems™ kit. Although all amino acid concentration measurements from dried blood spots did not provide “acceptable” values with the current kit and with the stated derivatization scheme, the utility of the MALDI-MRM technique for high throughput screening for metabolic diseases has been demonstrated. With further routine experimentation the applicants would pursue efforts to measure acceptable concentrations for these amino acids, since the method provides such a novel and advantageous increase in speed of analysis compared to current state of the art methodology. Such efforts can include different derivatization schemes, particularly for the amino acids, as those skilled in the art would appreciate. FIG. 11 shows the excellent reproducibility of 12 identical amino acid MALDI-MRM measurements.

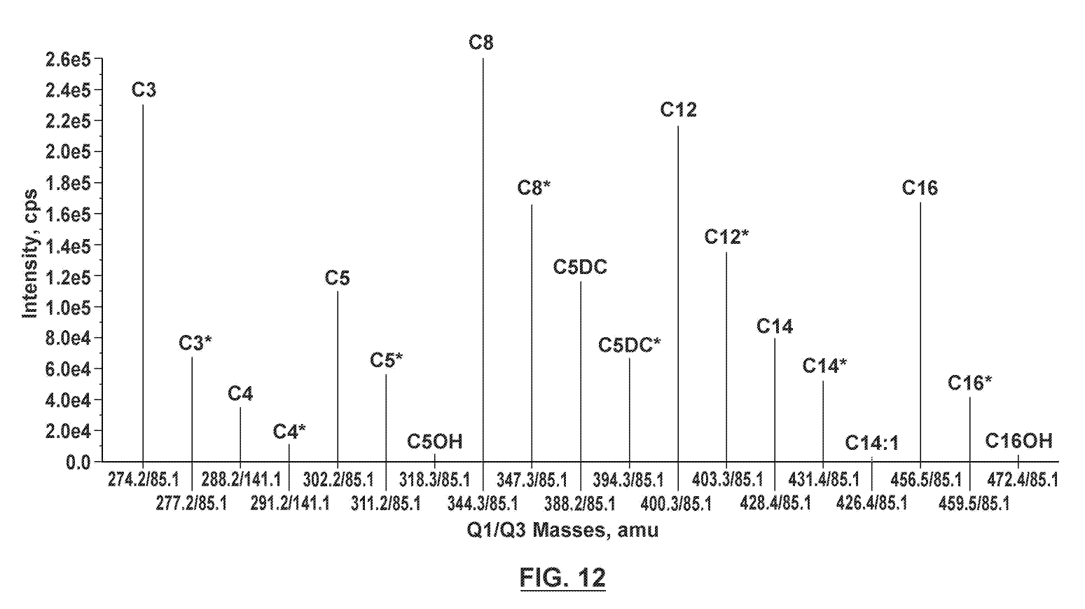

In practice there are over 70 acylcarnitines that are potentially of interest for biological screening, but there are no isotopically labeled internal standards available for all acylcarnitines. Since acylcarnitines with chain lengths of equal length provide similar mass spectrometric response, as is known to those skilled in the art, semi-quantitation of those acylcarnitines for which there are not internal standards is performed by referencing these analytes to deuterated internal standards of the same chain length. FIG. 12 shows the results of an MRM acylcarnitine first pass screen for which 19 ion pairs were monitored as the laser traversed the sample spot at 1.5 mm/s, with MRM dwell times of 7 ms, producing an MRM peak of width 1.2 seconds, full width at half maximum. In FIG. 12 the MRM peaks are not shown as ion signal as a function of mass spectrometer analysis time, as previously. In this case the MRM ion pair peak heights are plotted relative to one another, with the ion pair masses shown on the horizontal axis. Eleven of the ion pairs correspond to acylcarnitine analytes and 8 of the ion pairs correspond to internal standards (indicated by asterisks). Semi-quantitation results for C5OH, C14:1, AND C16OH are typically produced by taking the ratio of these acylcarnitines to the internal standards of corresponding equal chain lengths (C5, C14, and C16, respectively). The acylcarnitines included in a first pass screen, such as the one illustrated in FIG. 12, can be analyzed, preferably immediately after data acquisition, and if the results suggest possible presence of a disease a more specific MALDI-MRM method can be run for a more specific set of analytes for further screening detail and elucidation. Schemes such as these can contribute to further increases in the overall speed of screening of a multitude of samples.

As demonstrated above, the method can be simple and easy to use. It comprises (1) providing a biological sample, which can comprise some form of separation and/or derivatization, (2) depositing the sample on a surface (for example a MALDI plate), which may, or may not include mixing the sample with a UV light absorbing substance (for example, a MALDI matrix), and (3) analyzing the sample by a laser desorption ion source (for example, MALDI) coupled to a mass spectrometer.

The applicant's teachings also can include the deposition of liquid chromatography (LC) traces onto the target plate and the subsequent analysis using a laser desorption ion source, in which the ions are damped/cooled with a damping gas and then analyzed using a mass analyzer (for example, oMALDI) and the applicant's method. LC can be very useful for providing isomeric and isobaric separation of analytes of the same mass prior to spotting on the target (for example, MALDI) plate. This combination of LC separation, deposition of the time-ordered LC effluent onto the target (e.g. MALDI) plate, and subsequent analysis by MALDI (or another method of laser desorption ion source coupled to a mass analyzer) is referred to as LC-MALDI. In the metabolic screening application LC-MALDI can provide isomeric and isobaric separation of leucine/isoleucine/hydroxyproline and glutamine/lysine for the purposes of quantification. A case where leucine measurement alone can be helpful is in distinguishing between hyperleucinemia and MSUD. With LC-MALDI, the separation of analytes such as these can then be “frozen” onto the sample plate and can be interrogated in whatever useful manner the practitioner selects, with several interrogations of the same LC traces possible. This is in contrast to ESI-MS-MS where the LC effluent is routed into the mass spectrometer as it exits the LC column and analysis occurs in one timed pass only.

Although deposition of LC traces onto a target plate and subsequent analysis with the applicant's technique is not faster than simply performing LC/MS/MS for the same samples, the speed of the applicant's method can permit increased sample throughput when multiple LC deposition systems are run in parallel, producing a number of spotted target plates for analysis by the applicant's method. This multiplexing to provide more samples for the fast MALDI-MRM analysis greatly increases sample throughput. The applicant's teachings also can provide increased multiplexing capabilities (for example, including the analysis of two or more analytes from the same sample spot) due to the ability to analyze a greater number of analytes because of the increased speed of acquisition.

Further, a specific sample can be analyzed for one or more biological disorders. For example, a sample can be analyzed for amino acid disorders and fatty acid oxidation disorders (by measurement of acylcarnitines) from the same sample spot. The analysis of two or more disorders from the same sample spot can be considered “simultaneous” in that although the mass spectrometer analyzes for amino acid and acylcarnitines separately, but within the same mass spectrometer method in an interleaving manner, the time delay between the two analyses can be in the millisecond range. Indeed, the analysis of the entire target surface (for example the MALDI plate) can be considered a multiplex system due to the number of different samples that can be analyzed easily and at great speed.

The applicant's teachings can provide use of a laser desorption ion source, in which the ions generated from the ion source can be collisionally damped/cooled with a damping gas and analyzed in a mass analyzer. Accordingly, the applicant's teachings can include the use of oMALDI in combination with tandem triple quad mass analyzers or ion traps, including hybrid quadrupole/linear ion trap tandem mass spectrometers to analyze biological disorders, including but not limited to, metabolic disorders such as amino acid disorders, fatty acid oxidation disorders, and organic acid disorders. MRM can be available on triple quadrupole mass analyzers. A hybrid quadrupole/linear ion trap-type instrument provides an alternate approach to oMALDI on a triple quad mass analyzer and to LC-MALDI, since methods can be developed that take advantage of the higher degree of selectivity and specificity provided by ion trap scans.

The applicant's teachings can include analysis of biomarkers in positive ion mode or negative ion mode.

The applicant's teachings can be used in comparing the levels of biomarkers in a patient to the levels in a normal individual. This can be accomplished by measuring MRM peak areas for a number of analytes, from the same sample spot, calculating ratios of these analytes, and comparing these ratios to corresponding ratios known to represent a “normal”, non-disorder case. One or more of these ratios can involve an internal standard. “Normal” ratios have been set in the prior art, as a result of the screening of many individuals, healthy and in disease states.

The applicant's teaching can demonstrate that the target surface (for example the MALDI plate) can comprise samples from one or more patients and control samples. There can be one, or more sample spots on the plate, for the same patient. There can be repeat sample spots for which all preparations were the same. This would facilitate screening for a number of disorders, for the case where one sample spot on the plate is not enough material. In this case amino acids and acylcarnitines might be analyzed from the same sample spot on the plate, and even using the same MS method (i.e. different mass spectrometer methods for amino acids and acylcarnitines are not necessary). There could also be one (or more) sample spots on the plate, for the same patient, from each of several different preparations (e.g. one for fatty acid oxidation disorders and one for amino acid disorders). For example, for the same patient the spots on the plate could be 3 spots for amino acid disorders (with its preparation) and 2 spots for organic acid disorders (with a different preparation) with all spots originating from the same single blood sample from the patient.

Accordingly, the applicant's teachings can demonstrate that judicious choice of sample spotting locations on the MALDI plate, or repeat spotting of the same sample, can provide novel, fast analysis for particular disorders or for suites of disorders. For example, in some cases, different sample preparations can be prepared from one or more dried blood spots from a single patient. For example, in the case of analysis for amino acids and acylcarnitines from the same sample spot, and even within the same mass spectrometer method, methanol extraction typically can be used followed by derivatization with butanolic HCl. As is known to those skilled in the art, a further step performed by some practitioners of NBS can involve further extraction and/or derivatization, perhaps with other chemicals or solvents. These various sample preparations can be performed “off-line” from the MALDI-MS-MS system, and when using the ESI-MS-MS method of analysis they can require multiple sample injections to the mass spectrometer system. The applicants' method can permit these various different sample preparations to be spotted onto the same MALDI plate, in whatever order the practitioners find most advantageous to their workflow. This can result in further significant increased overall speed of analysis, beyond that simply provided by the rate of one ion pair per second or two.

Comparisons to indicate the speed increase of oMALDI-MS-MS can be dependent on exactly what diseases are being analyzed. The fastest disorder screening by ESI-MS-MS involves screening for a number of disorders, from one blood spot, in a single sample injection into the mass spectrometer system. In this manner, the “overhead” times for sample injection and system washing (to prevent sample carryover) can be minimized as compared to analysis for one disorder for each sample injection. In the multi-screen approach, ESI-MS-MS state of the art indicates that one sample can be processed approximately every 120 seconds (from the literature, Chace and Kalas, Clin. Biochem., 38, 296-309 (2005); Chace et al., Clin. Chem., 49 (11), 1797-1817 (2003)). For the purpose of comparison, the following is an example for the analysis of 13 acylcarnitines and 12 amino acids, for a total of 25 analytes, by MALDI-MRM at an easily attainable sample throughput rate. It is noted that standard ESI-MS-MS analyses usually monitor less than 25 analytes. In the worst case, where each of these 25 analytes requires its own internal standard, in the oMALDI-MS-MS technique these 50 compounds can be grouped into 5 groups of 10 compounds and the system can analyze 10 compounds per sample spot. At a rate of 2 seconds per sample spot, the oMALDI-MS-MS analysis requires approximately 10 seconds to complete the entire analysis, which is approximately 10 times faster than the state of the art ESI-MS-MS analysis. Highly targeted analyses, such as for PKU, for example, can occur in well under one second with the oMALDI-MS-MS technique, as indicated from FIG. 4.

The applicant's teachings also can provide kits for use in the analysis of biological disorders, in particular newborn screening for biological disorders. Biological disorders can be, but are not limited to, metabolic disorders such as amino acid disorders, fatty acid oxidation disorders, and organic acid disorders. The kits can comprise one or more of the following: reagents and accessories needed for sample collection (e.g. needles, DBS filter paper, hole punch), reagents required for sample preparation, for example, sample separation or derivatization (pure reagents and solvents, filters, columns, liquid chromatography (LC) buffers, collection tubes, MALDI matrix, other UV light absorbing compounds), analytes (unlabeled standards and labeled internal standards), and target surfaces, for example MALDI plates or plates with purposely designed surface treatments which eliminate the need for MALDI matrix yet still provide adequate desorption and ionization from the surface, or perhaps control or standard pre-spotted MALDI plates, software for easy data analysis for screening purposes, instructions for sample collection, preparation and analysis, as well as instructions for use of MALDI-MS-MS or other laser desorption ion sources, in which the ions are damped/cooled with a damping gas and then analyzed using a mass analyzer.

### Example 2

### Establishing Useful Derivatization Protocols for Analytes of Interest to Achieve Efficient Ion Production and Analysis Via MALDI MS/MS

For analysis of amino acids and acylcarnitines a derivatization method modified from two literature methods (Chace et al., Clin. Chem., 39 (1), 66-71 (1993); Chace et al., Clin. Chem., 41 (1), 62-68 (1995); Chace et al., Clin. Chem., 42 (3), 349-355 (1996) was found to be useful. The protocol involves derivatizing the sample with butanol HCl, and the method was extended to included sample preparation for MALDI spotting, by mixing with MALDI matrix prior to spotting on the MALDI plate. In particular, the method can include the following steps, although the steps can be changed, substituted or omitted as is known to those skilled in the art:
a) Mix together internal standards of amino acids and acylcarnitines to a final concentration of 1 mg/ml in 0.1M HCl and serially dilute with 50% MeOH. Dry mixtures under gentle N₂ stream.
b) Add 50 ul of 3M butanol HCl to each tube and incubate for 15 minutes at 65° C.
c) Dry tubes under gentle N₂ stream.
d) Suspend precipitate in 50% acetonitrile+0.1% formic acid. Prepare further serial dilutions as required.
e) Mix 1:1 with CHCA (α-cyano-4-hydroxycinnamic acid) MALDI matrix and spot 0.75 ul on MALDI plates.

The most common derivative is formed by esterification of the carboxylic groups with butanol. The derivatized samples are referred to as “butyl ester derivatives of amino acids”, for example. Under MS-MS conditions the butyl esters provide a fragmenting mass of 102 Da (butyl formate), which can be used in a particular MS-MS scan type (neutral loss of 102 Da). Several amino acids (cysteine, lysine, homocysteine, and tryptophan) require a special modification to the sample preparation process (addition of a reducing agent is required to prevent disulfide formation) (Magera et al., Clin. Chem., 45 (9), 1517-1522 (1999); Accinni et al., J. Chromatogr. B., 785, 219-226 (2003).

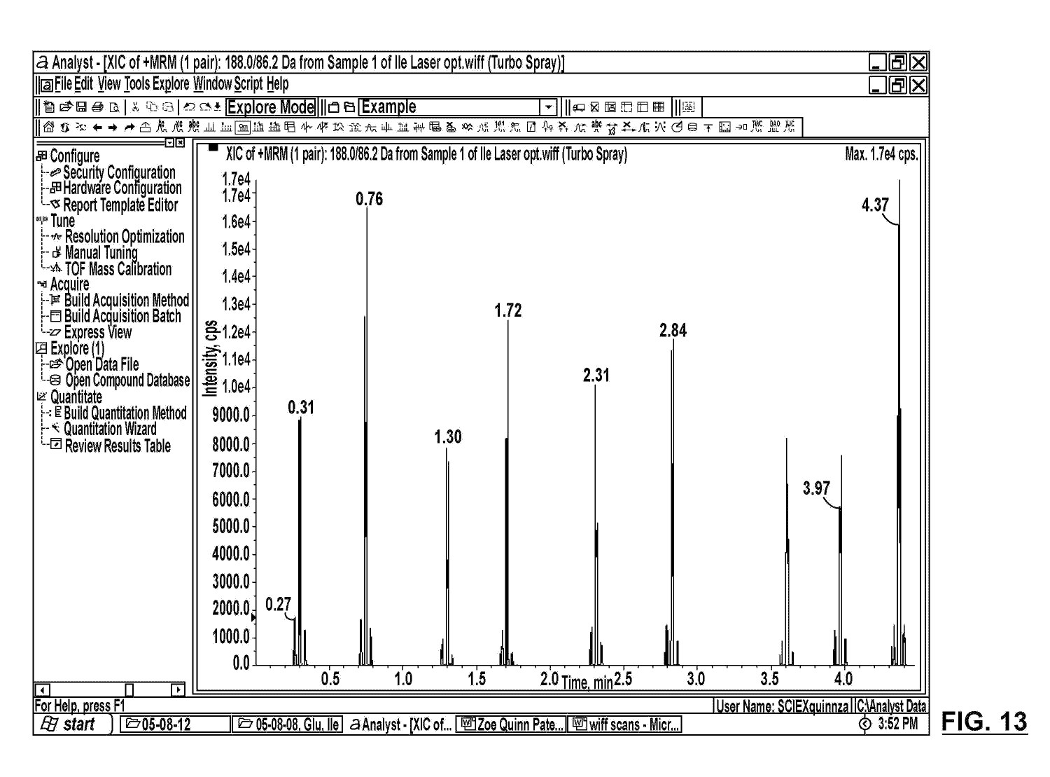

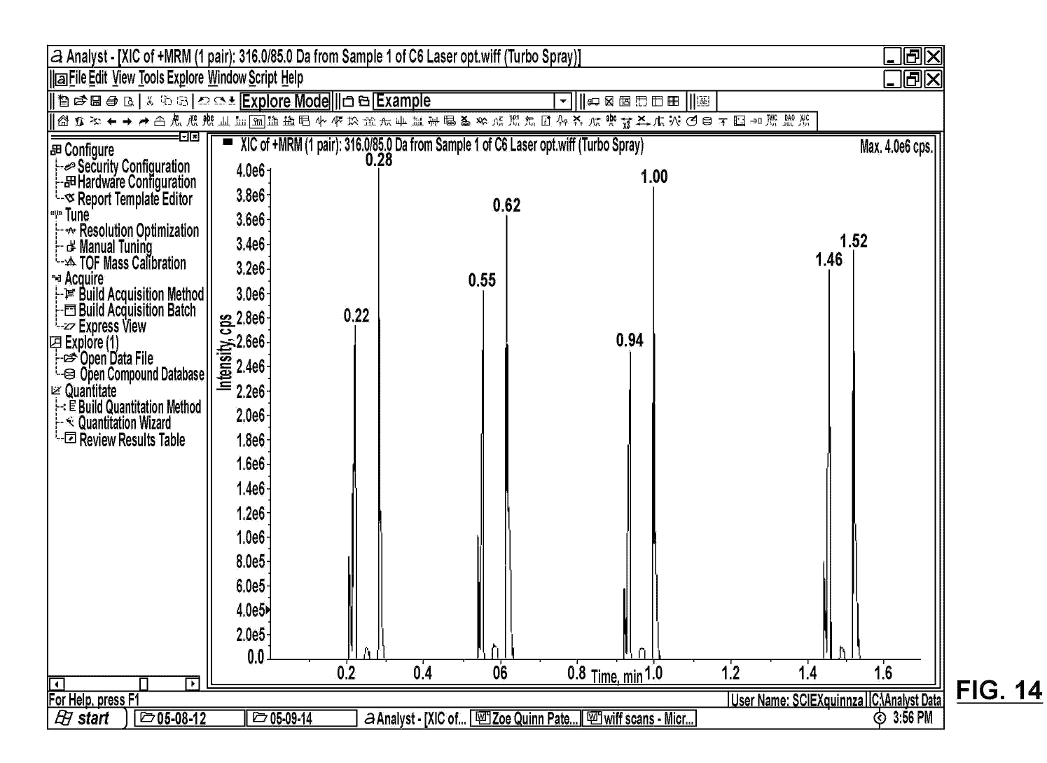

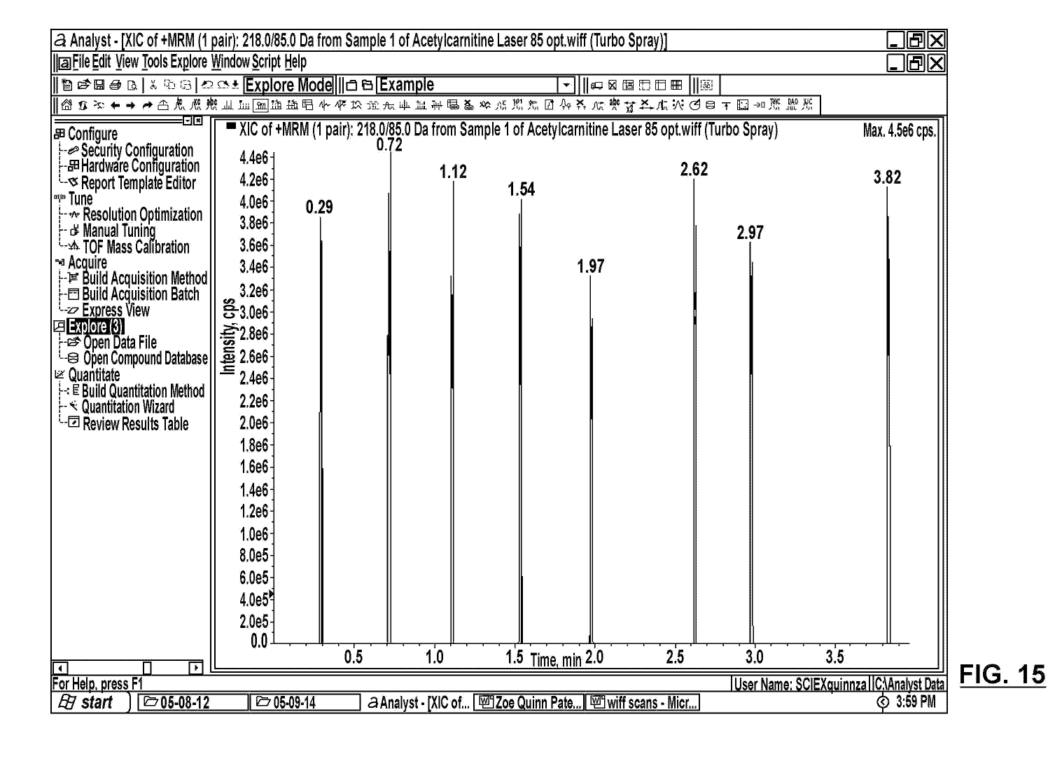

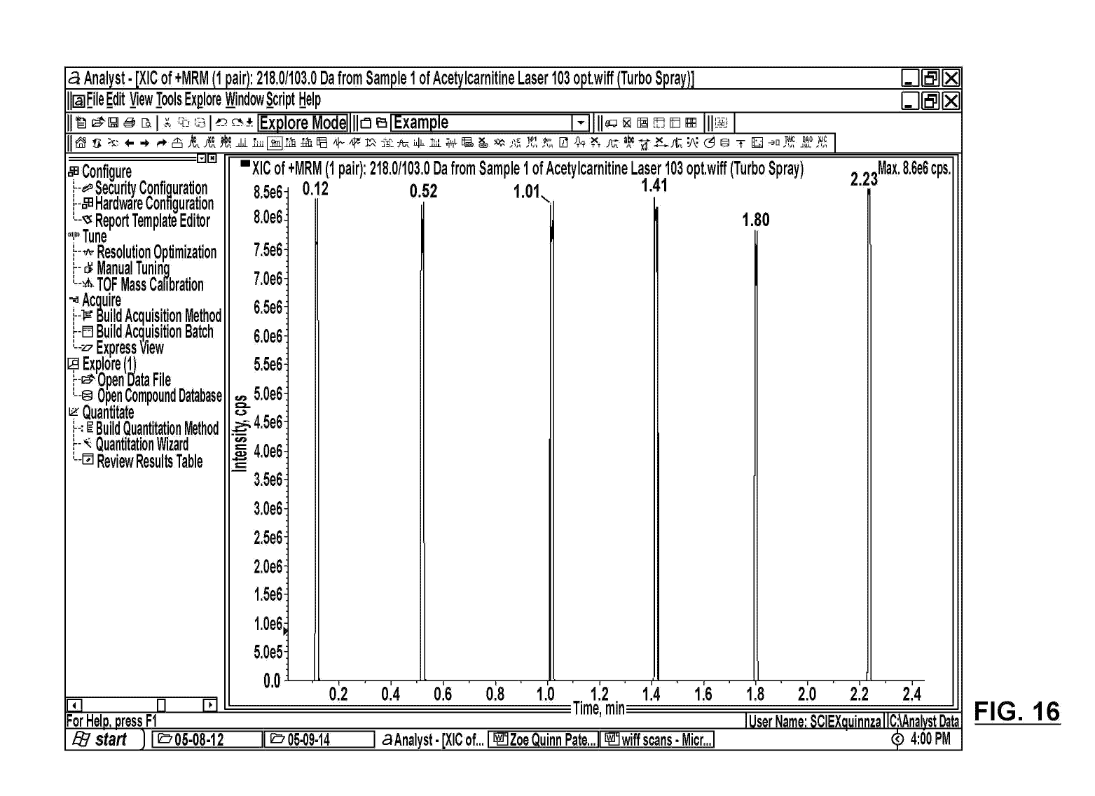

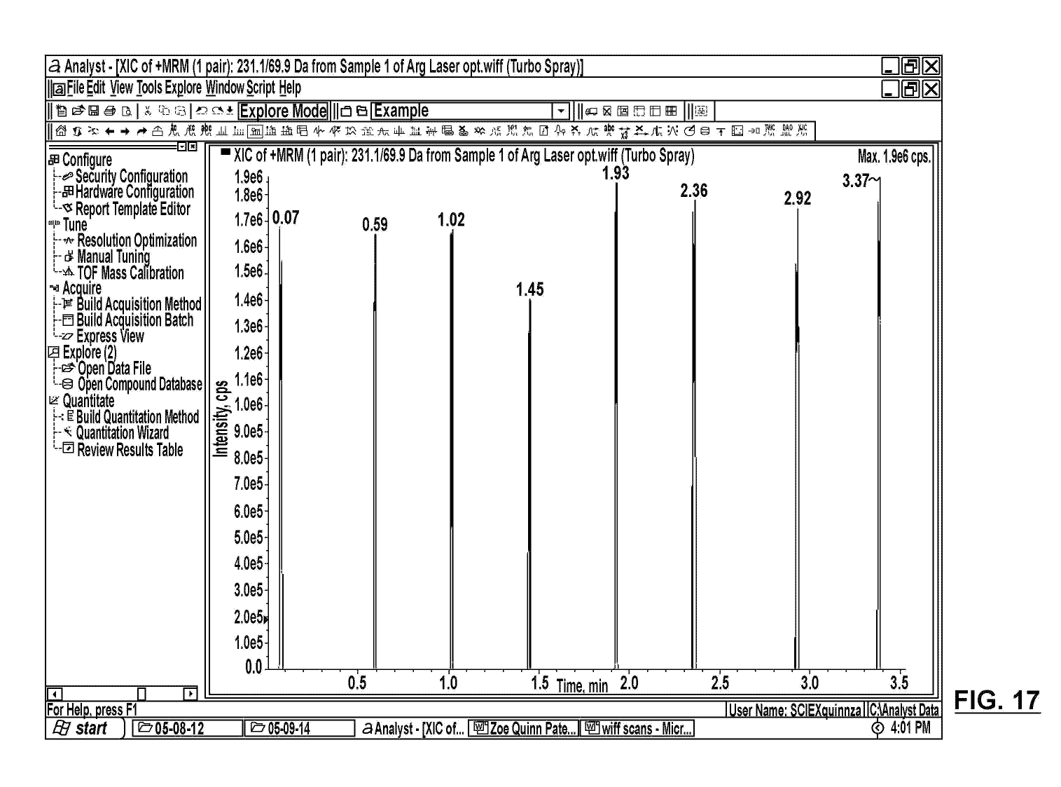

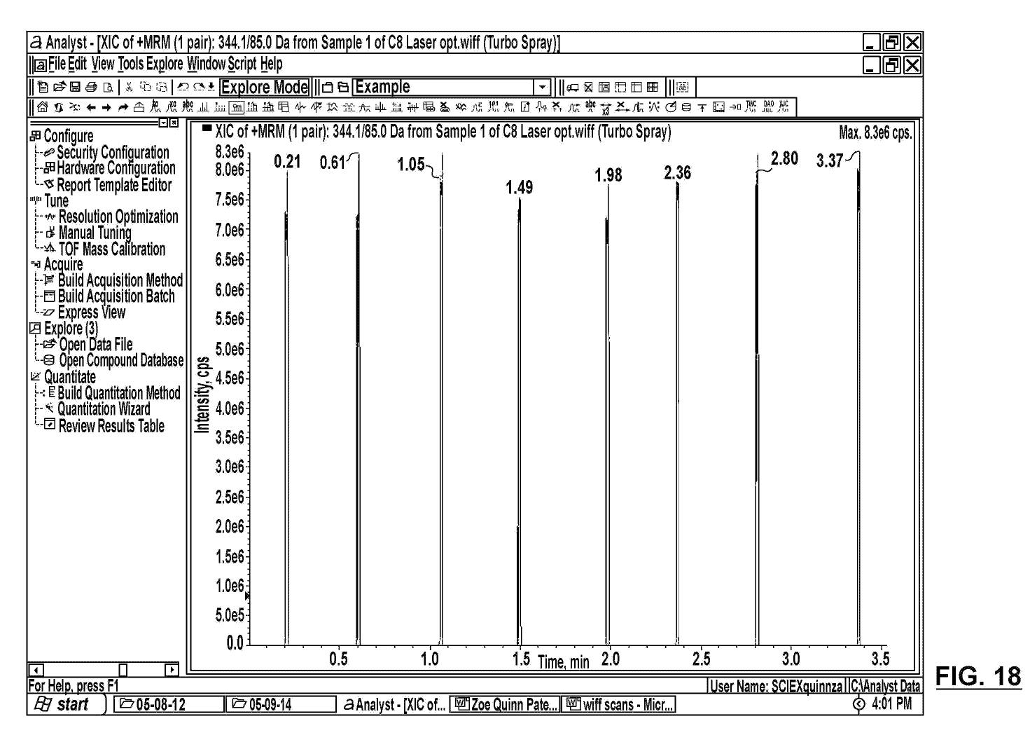

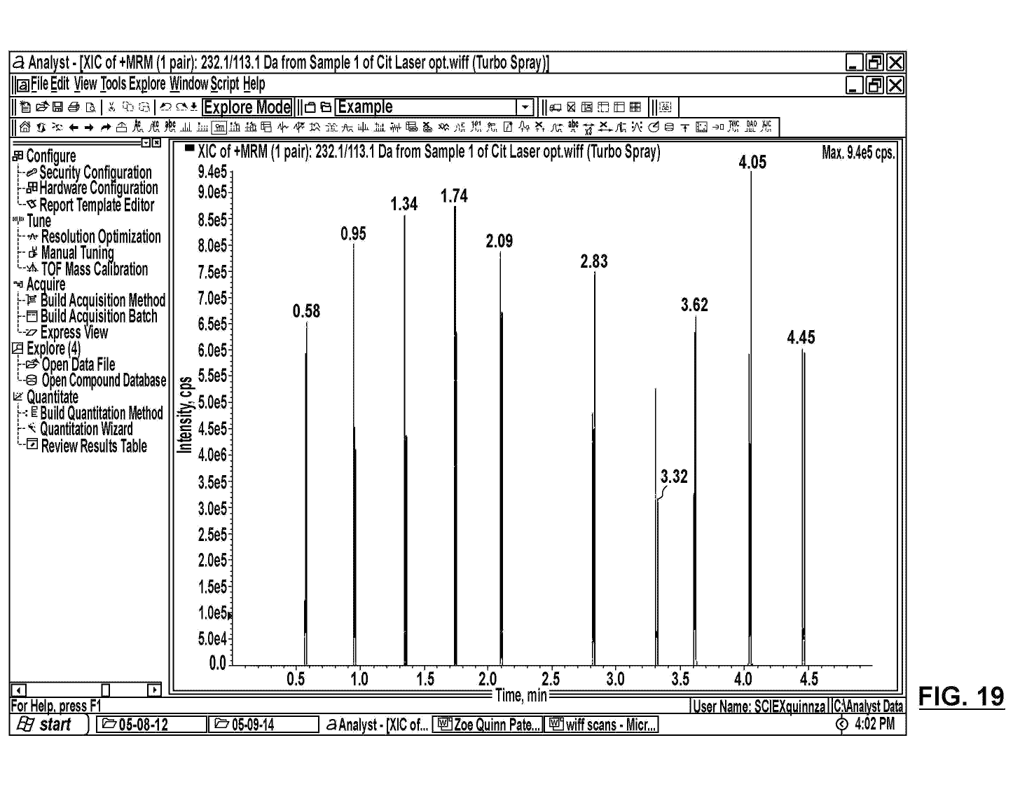

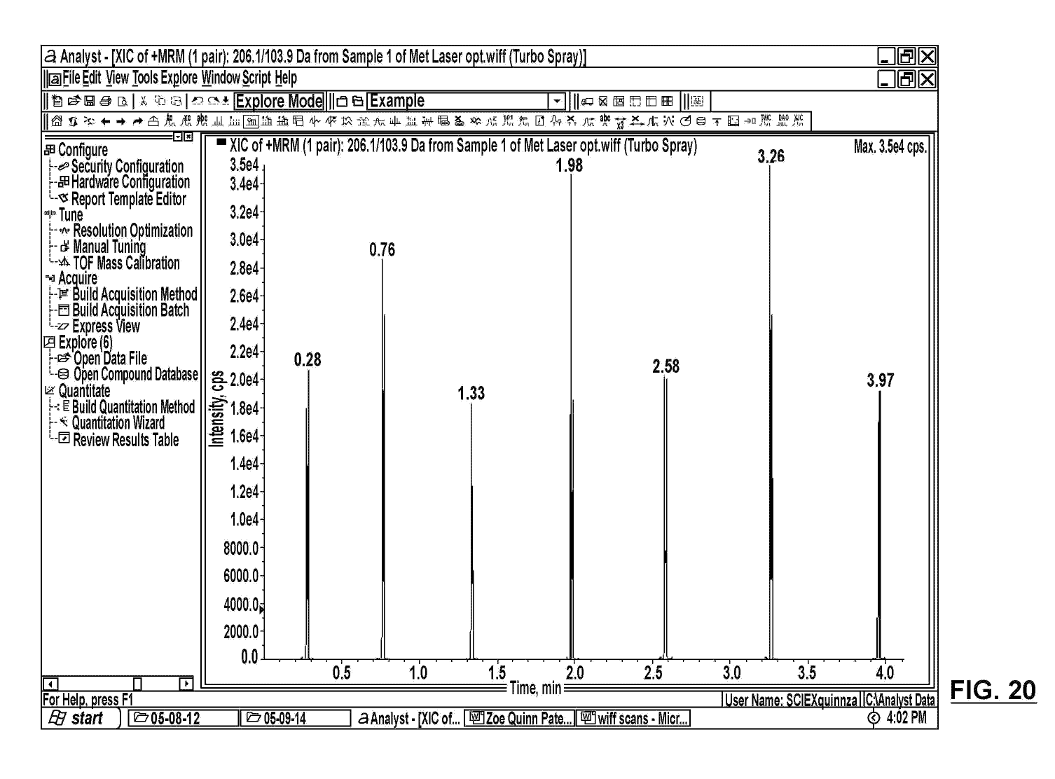

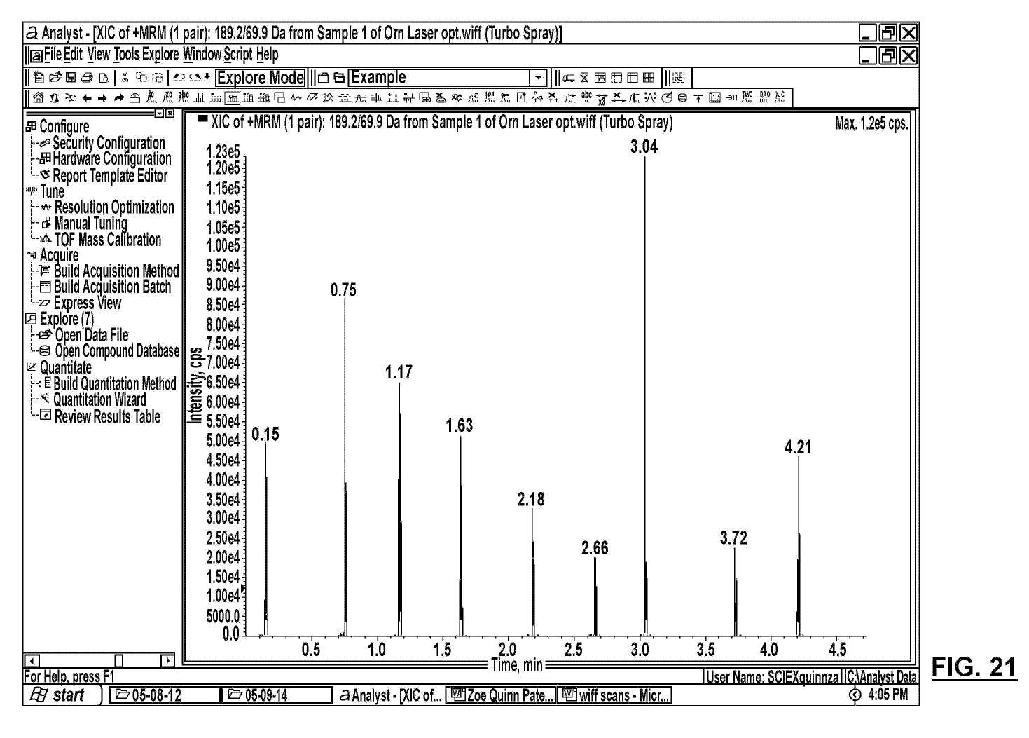

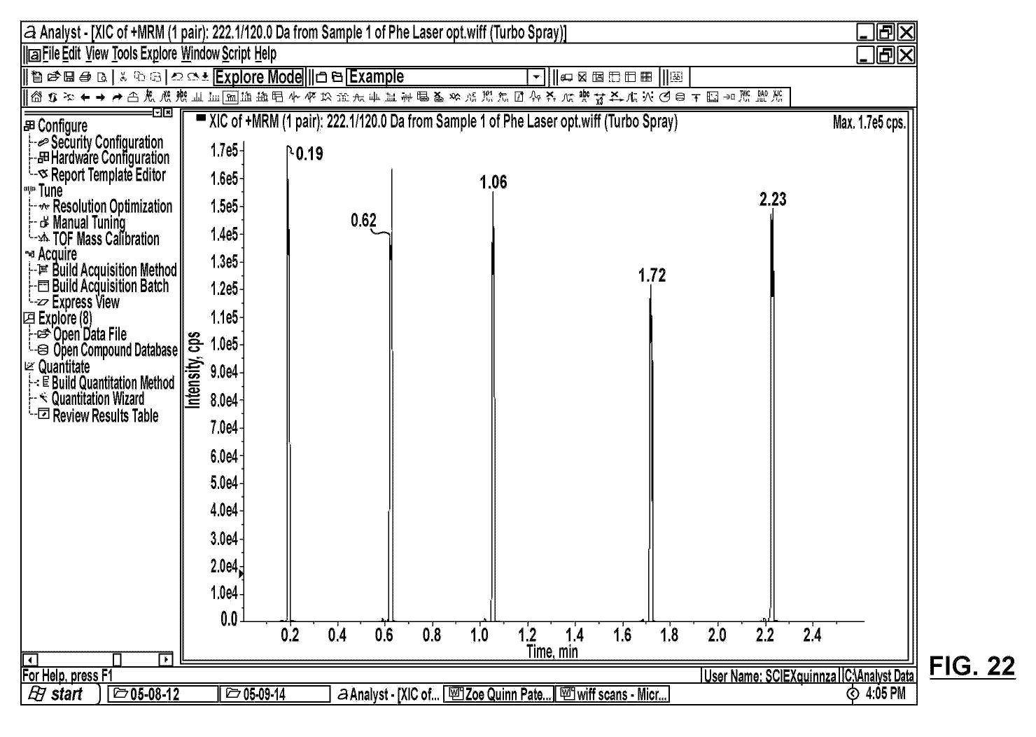

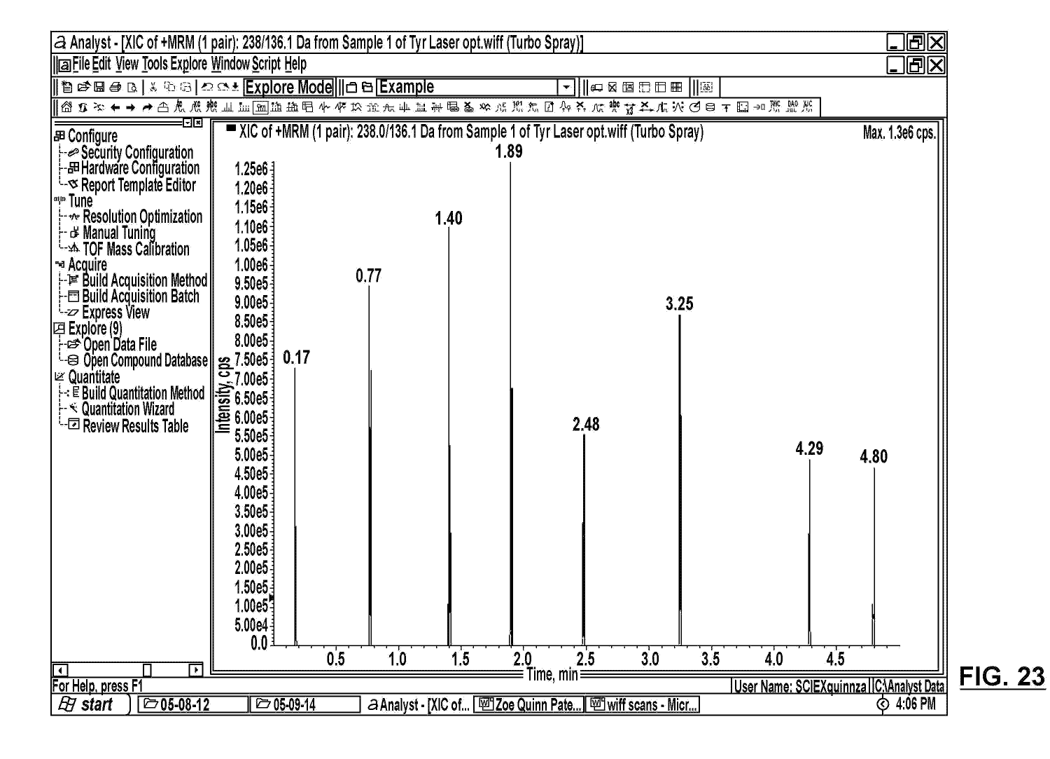

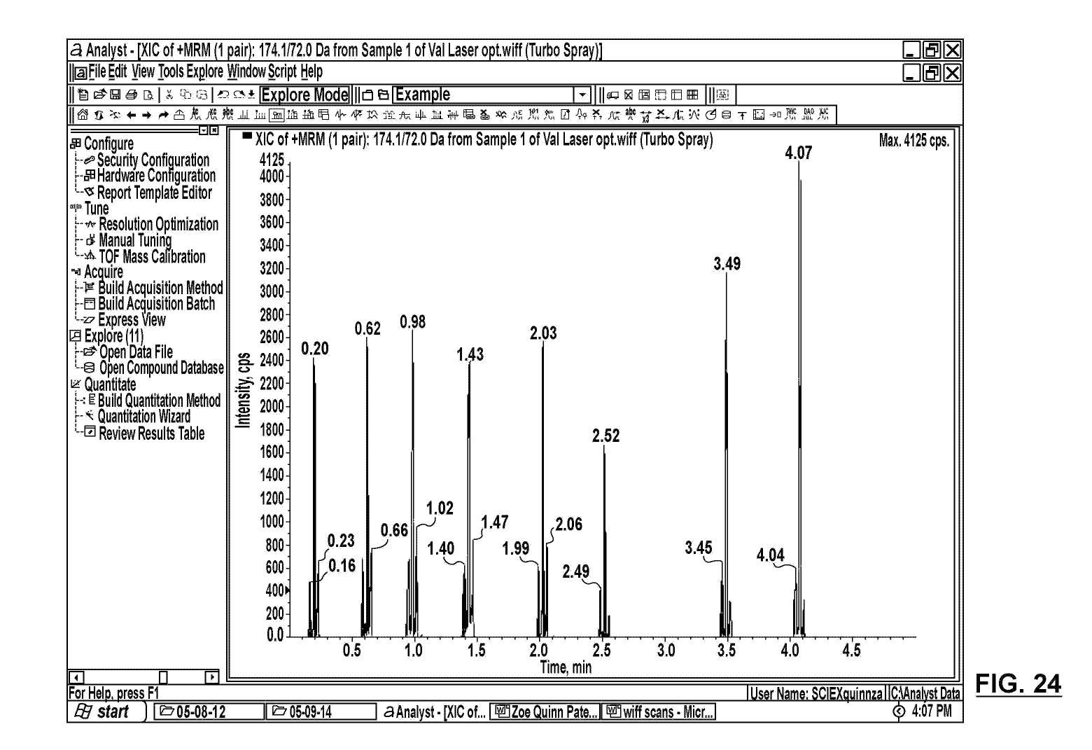

FIGS. 13-24 show spectra of MRM transition ions of several analytes. This preliminary data was acquired by using oMALDI on a triple quadrupole mass spectrometer operating in MRM mode.

### Example 3

### Determining Panels of Analytes that can be Analyzed

The applicant's teachings can provide unique screening capabilities, mostly because of the significant speed of analysis improvements. For example, to perform first pass screening, the one or two main analytes that act as potential indicators for a particular disease state can be readily analyzed in one or two seconds. It is, therefore, possible to apply methods that provide very fast first pass screening, the results of which may, or may not indicate the need for a next step. On the somewhat opposite end of the spectrum, if the intent of the screening is to make a determination of whether or not disease is present, then more analytes can be monitored for the particular disease state. In all cases, testing by an entirely different analytical technique is highly recommended to verify all positive results for a disease.

The following panels of analytes can be grouped together based on disorders, and can be analyzed in the same spot, in the same row of spots, or in the same plate of spots.

The following example considers 3 sample spots produced from the same single blood spot, and is an example of how groupings can be made to perform screening for a few of the disorders detectable by mass spectrometry and the applicant's teachings. Many other groupings are possible as is known to those skilled in the art. A maximum of 10 MRM ion pairs are used for the purpose of this illustration. The sample spots are of a finite size and rastering is performed such that signal remains steady throughout the raster while still obtaining enough data points across the MRM peaks to be able to legitimately perform semi-quantitation on the data. In a different example more than 10 MRM ion pairs could easily be used.

In the groupings below, IS means internal standard, for meaning of C2, C3, C4, C5, C6, C8, C10 see previous text.

### a) Group 1: Amino Acid Disorder Panel

### Analytes:

Phe, Tyr, Leu, Val, Met, and corresponding labeled internal standards

### Disorders:

PKU (phenylketonuria): Phe and Tyr

MSUD (maple syrup urine disease): Leu and Val

Homocystinuria: Met

### b) Group 2: Fatty Acid Oxidation Disorder Panel

### Analytes:

C4, C5, C6, C8, C10, and corresponding labeled internal standards

### Disorders:

MCAD (medium chain acyl-CoA dehydrogenase deficiency): C6, C8, C10

SCAD (short chain acyl-CoA dehydrogenase deficiency): C4

GA-II (glutaric acidemia, Type II): C4, C5, C6, C8, C10

### c) Group 3: Organic Acid Disorder Panel

### Analytes:

C2, C3, C4, C5, and corresponding labeled internal standards

### Disorders:

PA (propionic acidemia): C2, C3

MMA (methylmalonic acidemia): C2, C3

IVA (isovaleric acidemia): C2, C3, C5

IBD (isobutyryl-CoA dehydrogenase deficiency): C4

The panels above serve as examples to illustrate a method for screening for a number of different diseases, in a total of approximately 5 seconds, in accordance with the applicant's teachings. Many other panels or screens can be performed, and although much of the previous discussion involved derivatized amino acids and acylcarnitines, the techniques described in the applicant's teachings can also be applied to analysis of non-derivatized amino acids and acylcarnitines.

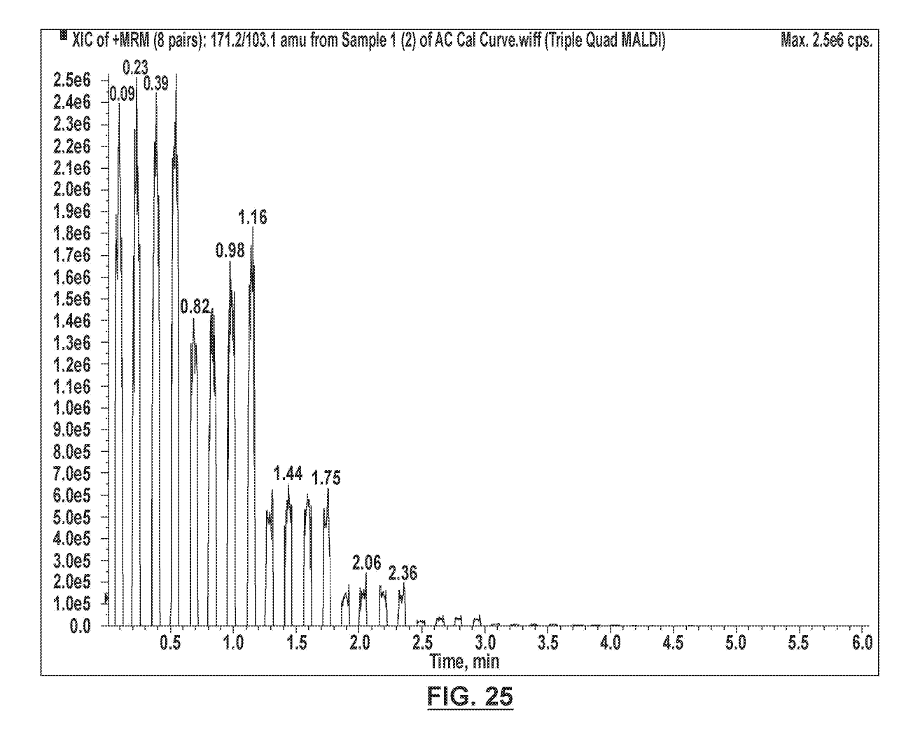

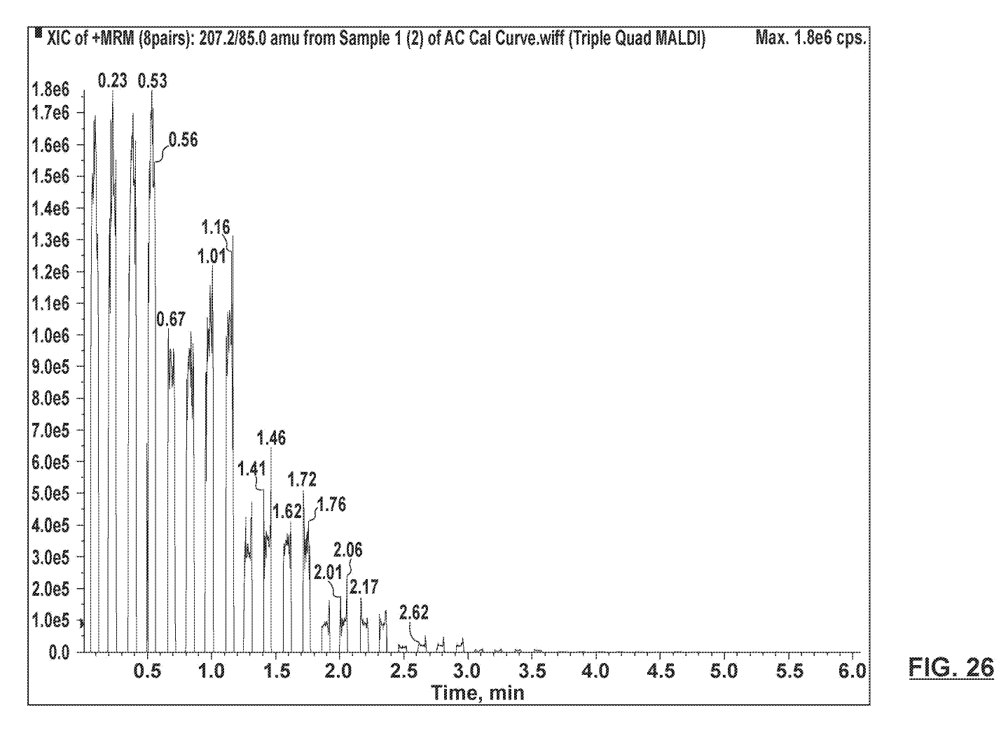

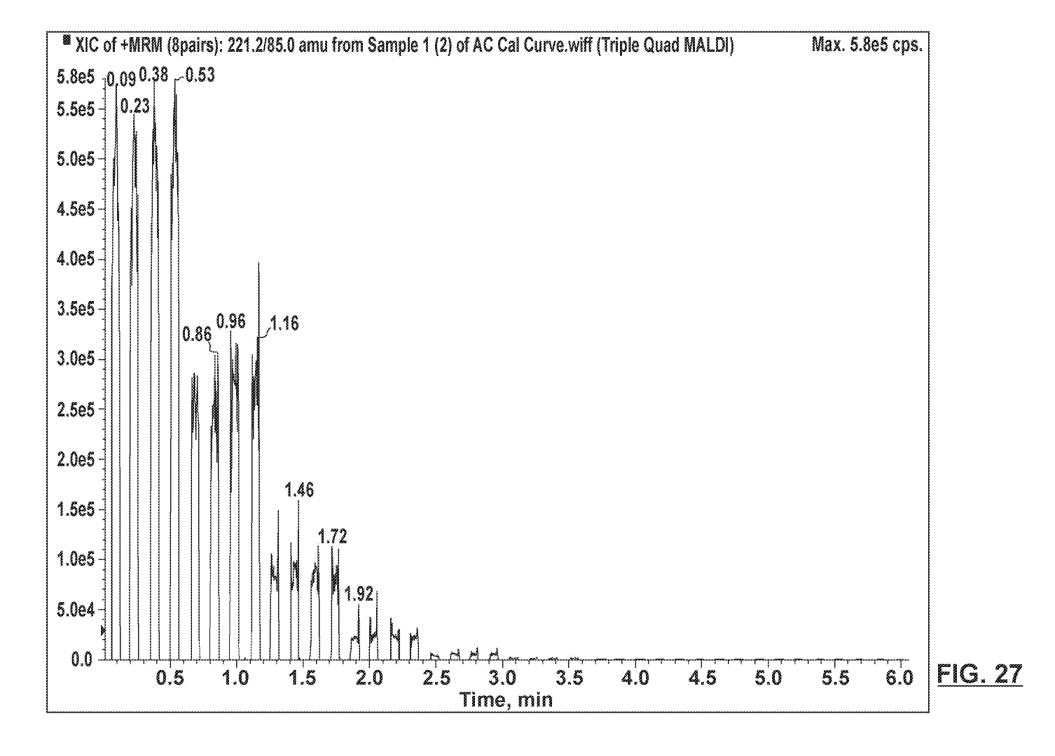

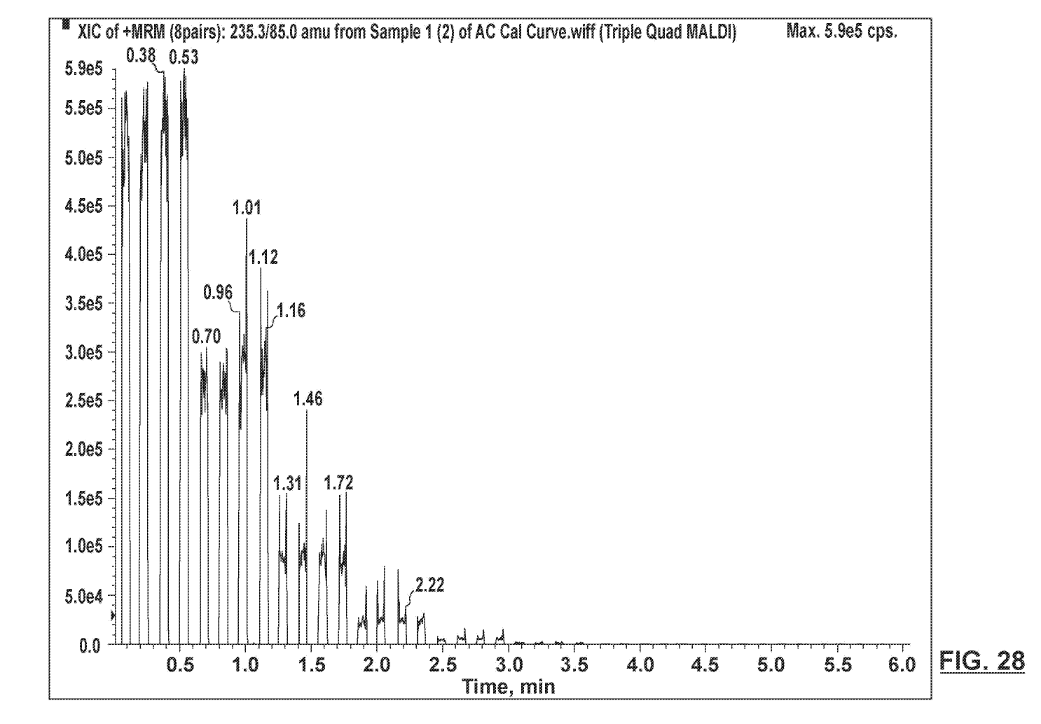

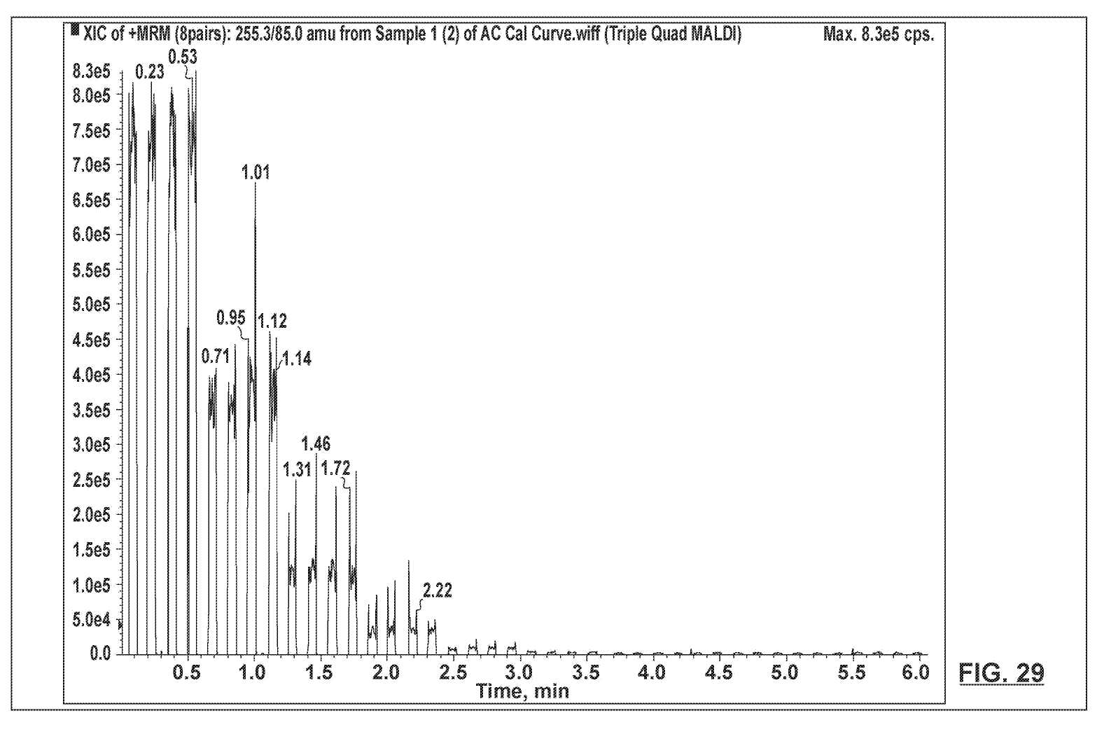

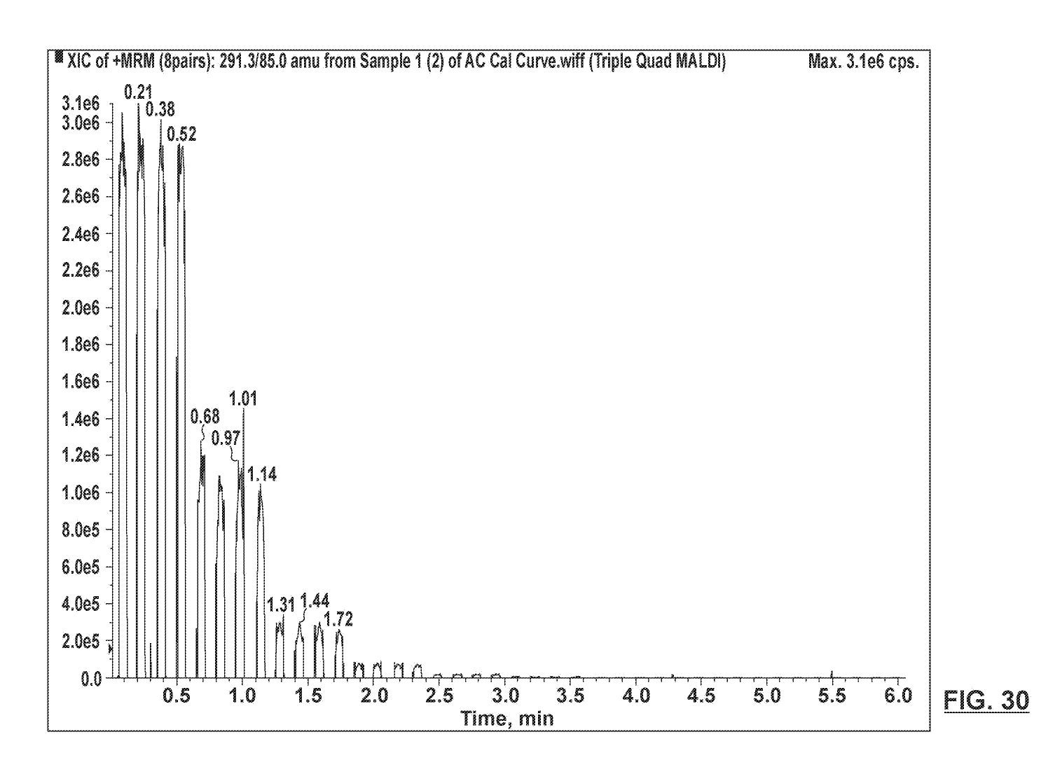

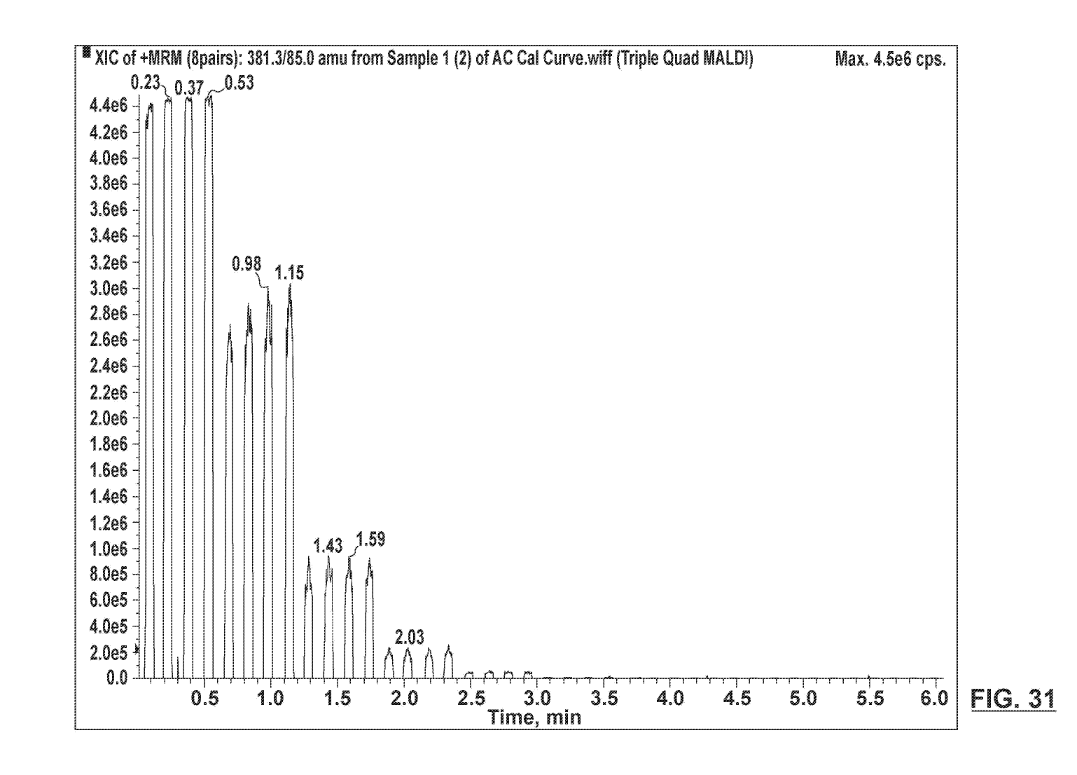

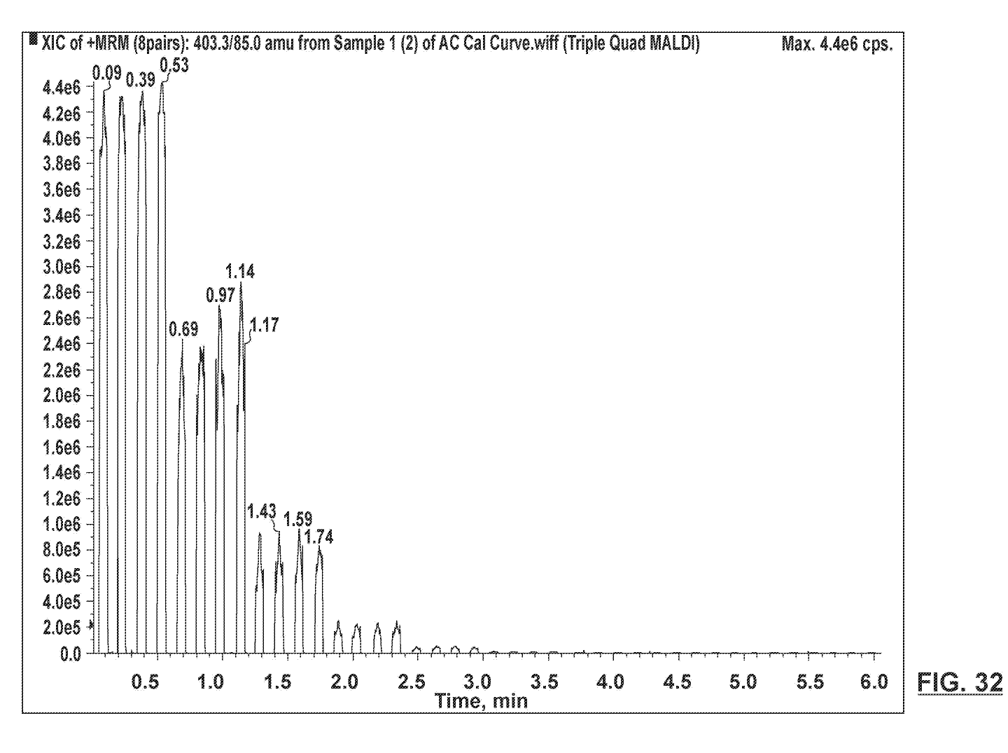

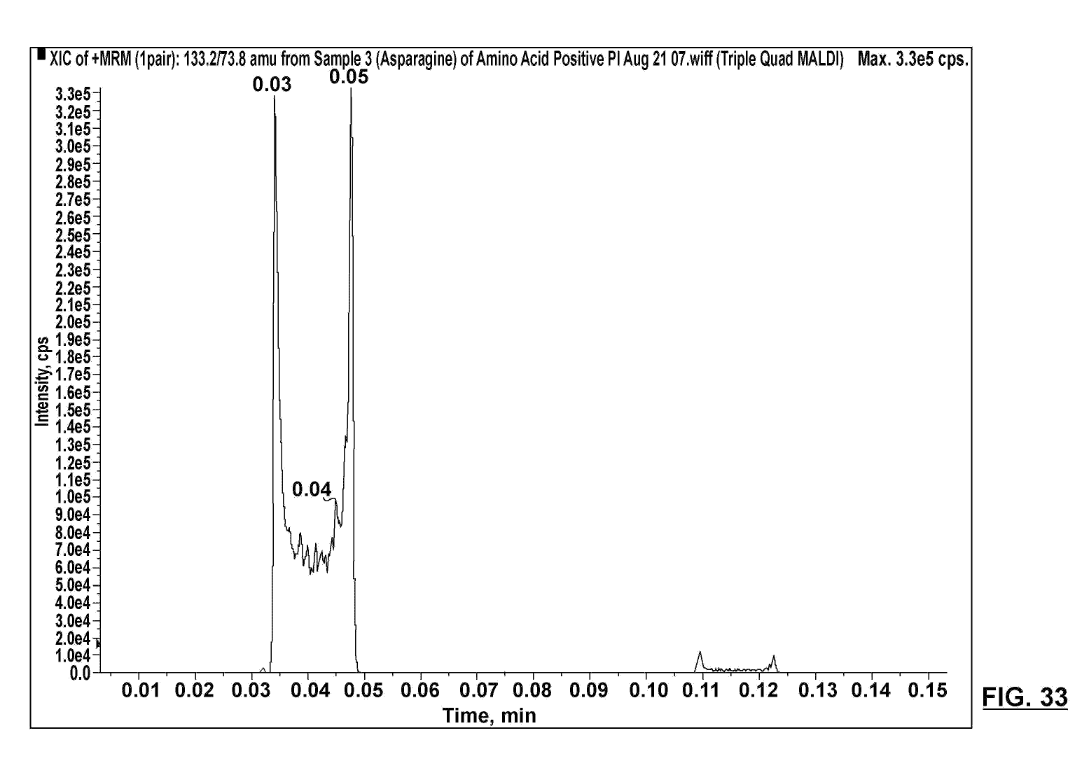

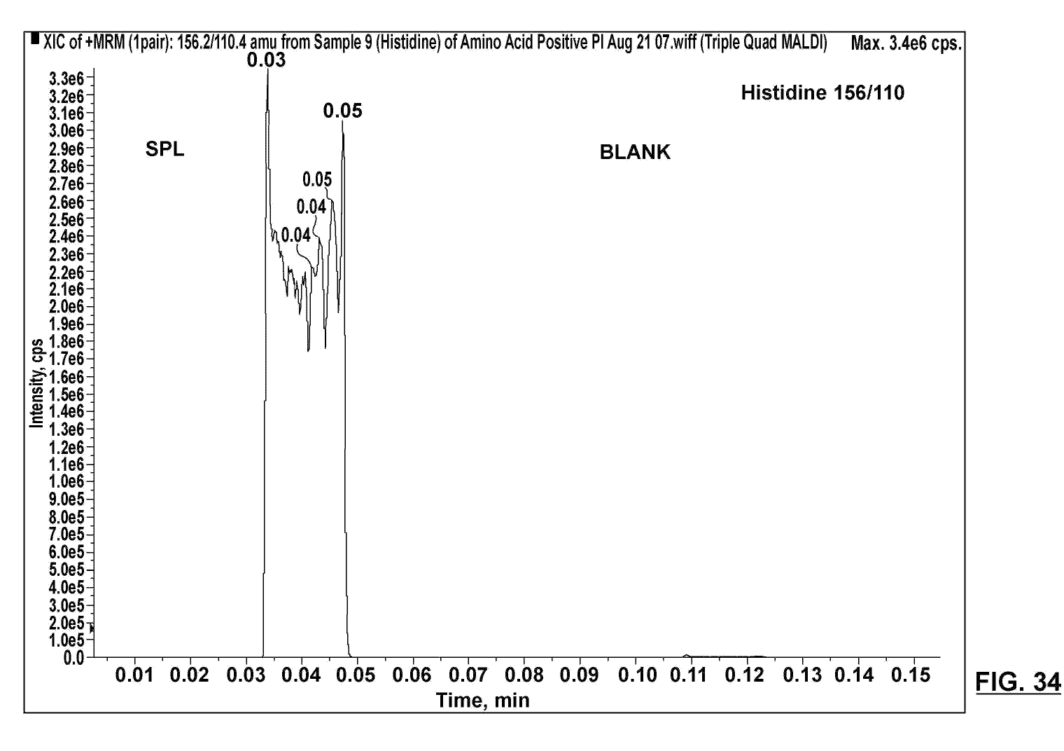

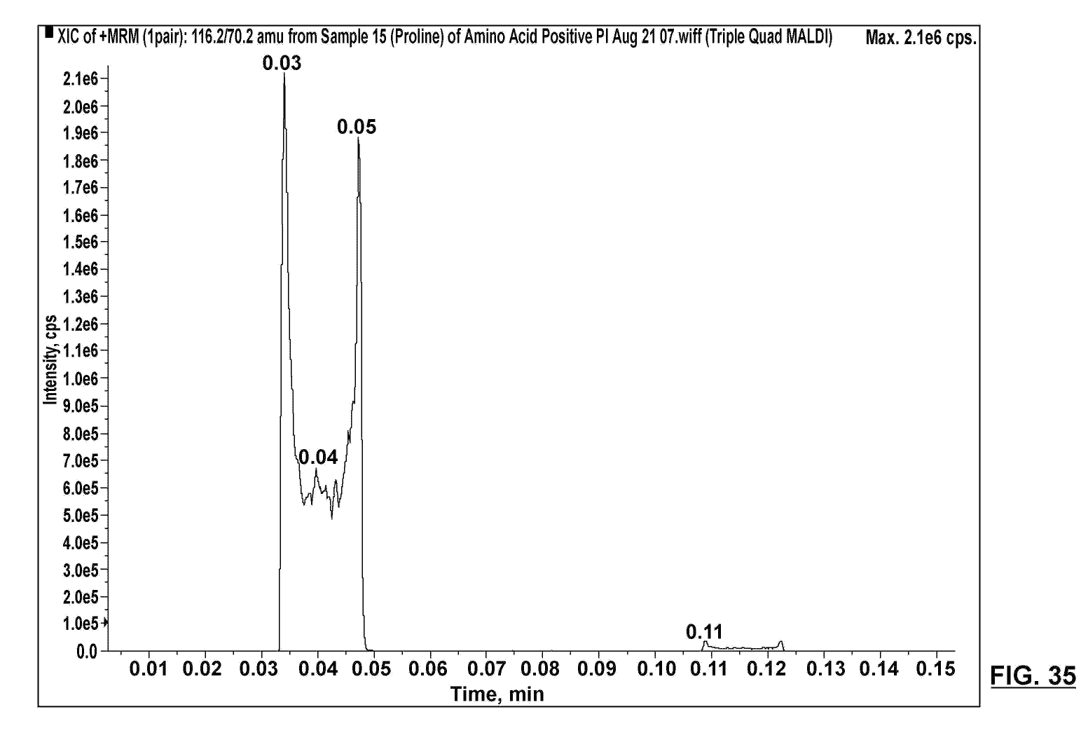

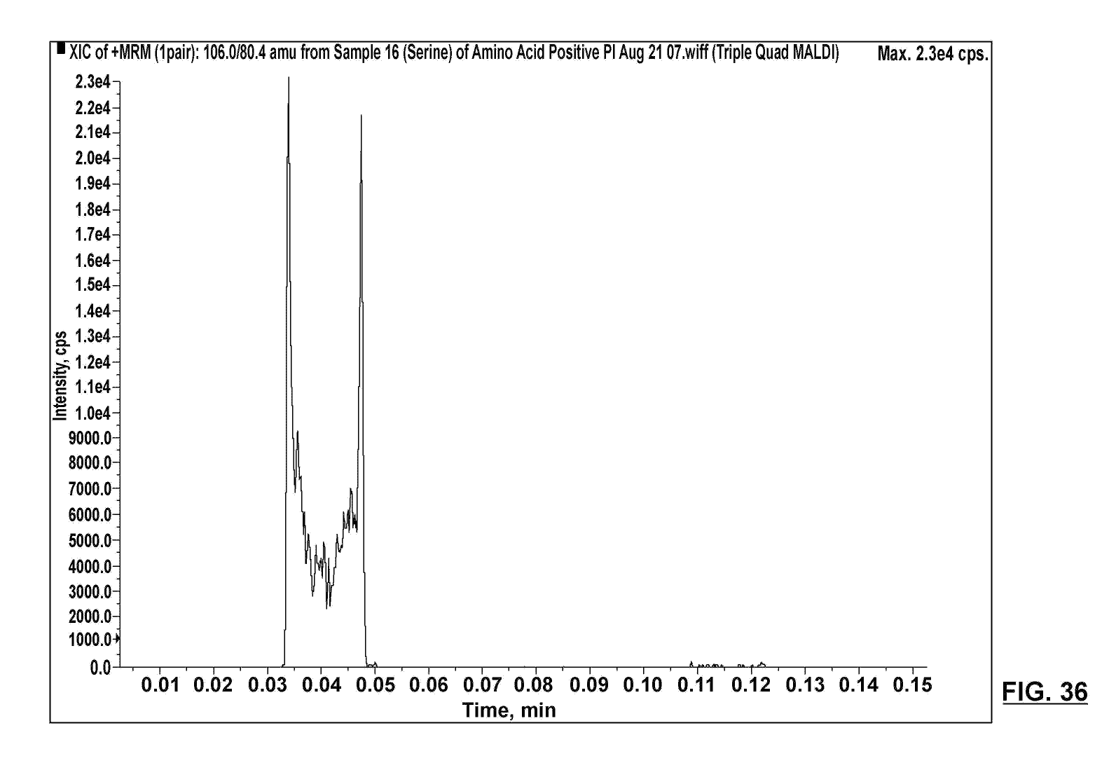

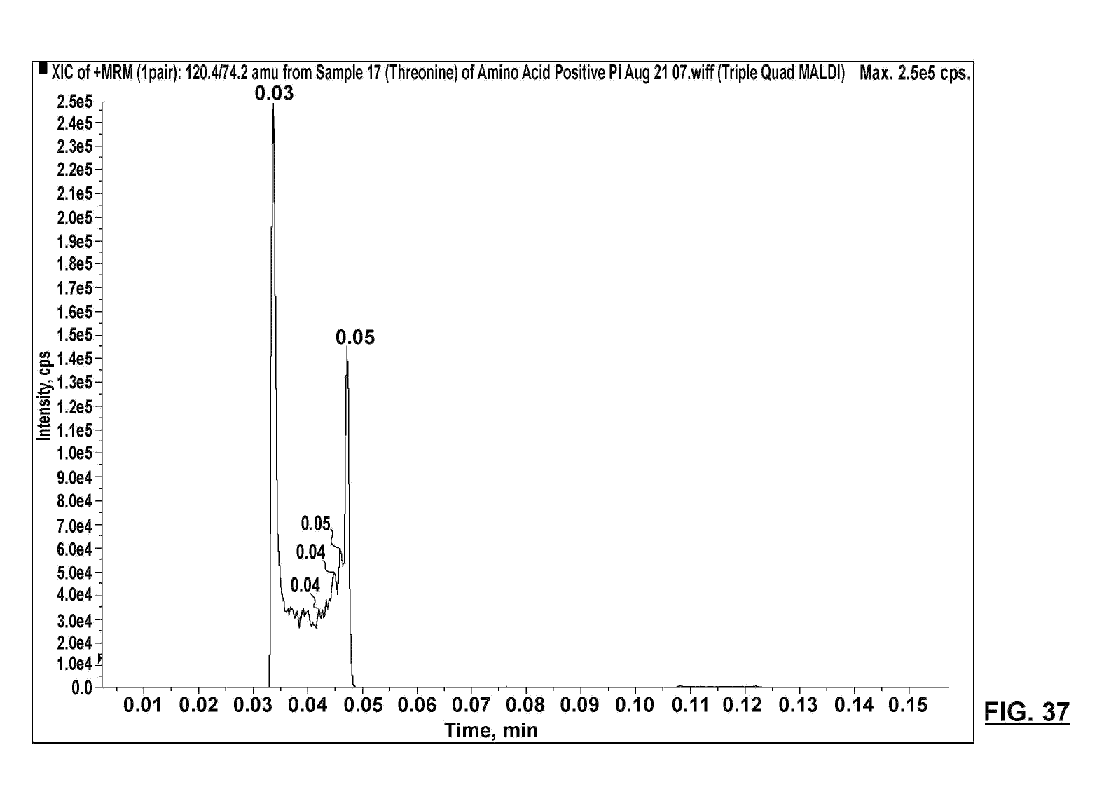

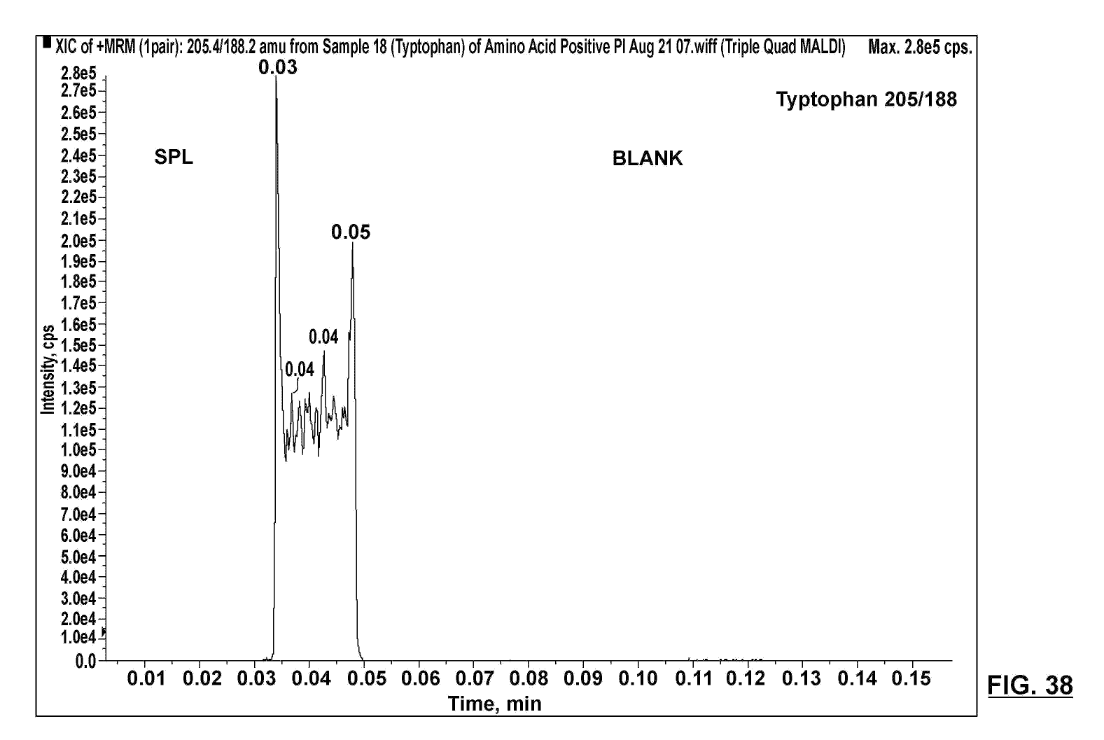

For example, FIGS. 25-32 show spectra of MRM transition ions of several underivatized acylcarnitines and well as free carnitine. FIGS. 33-38 show spectra of MRM transition ions of several underivatized amino acids. In FIGS. 33-38 the spectra show the signal from the analyte as well as the signal from the MALDI matrix blank.

A panel comprising C2, C3, C4, C5, C6, C8 and C10 was analyzed. Other combinations can also be analyzed.

### Example 4

### Acylcarnitine Pseudo-Screen

Although data presented in the application includes only some of the acylcarnitines as proof of principle, other acylcarnitines are important to NBS (for example, hydroxyacylcarnitines). Since isotopically labeled internal standards are generally not available for these other acylcarnitines they have yet to be analyzed by oMALDI. However, the fact that they are charged in solution, like the acylcarnitines, indicates that they would be successfully ionized by the oMALDI technique.

FIG. 12 shows an example of an acylcarnitine pseudo-screen that can be performed in less than 2 seconds for the purpose of first pass screening. As is known to those skilled in the art, this analysis for 11 acylcarnitines and reference to the 8 internal standards provides a broad enough coverage of the larger range of acylcarnitines to screen for disorders detectable by mass spectrometry. If disorders were present in the sample spots they would result in some abnormalities in the measured amounts of this set of acylcarnitines. Abnormalities would be “flagged” and more detailed analysis would be conducted, perhaps on the very same sample spots, but certainly on MALDI sample spots from the same dried blood spots. The MRM data in FIG. 12 included screening for two hydroxyacylcarnitines (C50H and C16OH). The exact analytes included in this acylcarnitine pseudo-screen can be varied by those skilled in the art, for different targeted screening. The same holds true for the exact number of analytes included in the screen.

### Example 5

### Large Scale Screen

The applicant's teachings can be used to construct a screen using, for example, 25 analytes and 25, or less, corresponding internal standards. For example, the screen can include all of the 13 acylcarnitines and 12 amino acids in the Chromsystems™ kit, and their respective internal standards. Such a screen can be accomplished by the use of one laser pass across one MALDI sample spot, in less than 5 seconds, for the purposes of monitoring the majority of amino acids and acylcarnitines of interest for NBS. The target plate can be set to move at slower speeds, near 0.5 mm/s, and MRM dwell times of 7 ms provide enough data points across the MRM peaks to provide acceptable data quality. Abnormal measured concentrations of analytes can be used to trigger more detail screening. Such a screen can include less than 50 total ion pairs and, as is known to those skilled in the art, such a large scale screen can include any mix of acylcarnitines and amino acids required for the purposes of the biological measurements.

As is known to those skilled in the art, the analysis for metabolic disorders can be performed for adults as well as newborns.

What is claimed is:

1. A method for analyzing a biological sample for a metabolic disorder, comprising:
(a) providing the biological sample; and
(b) analyzing the sample by a laser desorption ion source coupled to a mass analyzer.

2. The method of claim 1 wherein the step of analyzing comprises matrix assisted laser desorption ionization (MALDI) mass spectrometry.

3. The method of claim 1 further comprising collisionally damping/cooling the ions generated by the ion source with a damping gas.

4. The method of claim 3 wherein the step of collisionally damping/cooling is orthogonal MALDI (oMALDI).

5. The method of claim 1 wherein the metabolic disorder is a newborn metabolic disorder.

6. The method of claim 1 wherein the metabolic disorder is selected from the group consisting of amino acid disorder, fatty acid oxidation disorder, and organic acid disorder.

7. The method of claim 1 wherein the disorder is selected from the group consisting of phenylketonuria (PKU), hyperphenylalaninemias, maple syrup urine disease (MSUD), homocystinuria, citrullinemia (types I and II), argininemia, argininosuccinic acidemia (ASA), tyrosinemia (types I and II), homocitrullinuria, hyperornithinemia, hyperammonemia (HHH), methionine adenosyltransferase (MAT) deficiency, biopterin deficiencies, prolinemia, hypermethioninemia, gyrate atrophy of choroid and retina, medium chain acyl-CoA dehydrogenase (MCAD) deficiency, very long chain acyl-CoA dehydrogenase (VLCAD) deficiency, short chain acyl-CoA dehydrogenase (SCAD) deficiency, multiple acyl-CoA dehydrogenase (MAD) deficiency, long chain 3-hydroxyacyl-CoA dehydrogenase (LCHAD) deficiency, medium/short chain L-3-hydroxyacyl-CoA dehydrogenase (M/SCHAD) deficiency, trifunctional protein deficiency (TFP), carnitine palmitoyltransferase deficiencies of types I and II (CPT-I, CPT-II), carnitine-acylcarnitine translocase (CACT) deficiency, carnitine transporter deficiency, carnitine uptake defect, short chain 3-ketoacyl-CoA thiolase (SKAT) deficiency, medium chain 3-ketoacyl-CoA thiolase (MCKAT) deficiency, 2,4-dienoyl-CoA reductase deficiency, glutaric acidemia type II (GA-II), 3-methylcrotonyl-CoA carboxylase (3-MCC) deficiency, glutaric acidemia type I (GA-I), methylmalonic acidemias (MMA), propionic acidemia (PA), isovaleric acidemia (IVA), malonic aciduria (MA), multiple carboxylase deficiency (MCD), 2-methyl-3-hydroxybutyrl-CoA Dehydrogenase (MHBD) deficiency, 3-hydroxy-3-methylglutaryl-CoA lyase (HMG) deficiency, 2-methylbutyryl-CoA dehydrogenase (2 MBCD) deficiency, 3-methylglutaconic acidurias (MGA), isobutyryl-CoA dehydrogenase (IBD) deficiency, beta-ketothiolase deficiency (BKT), and ethylmalonic encephalopathy (EE).

8. The method of claim 1 wherein the step of providing the biological sample comprises derivatizing the sample and spotting on a target surface.

9. The method of claim 8 wherein derivatizing the sample comprises derivatization to butyl esteric form.

10. The method of claim 2 wherein the step of providing the biological sample comprises mixing the biological sample approximately 1:1 with CHCA.

11. The method of claim 1 wherein the biological sample is an underivatized amino acid or acylcarnitine and step (a) comprises (a) mixing the underivatized sample with UV substance and (b) spotting the underivatized sample on a target surface.

12. The method of claim 1 wherein the step of analyzing the sample comprises a tandem mass spectrometer, a triple quadrupole mass analyzer or an ion trap mass spectrometer.

13. The method of claim 12 further comprising multiple reaction monitoring.

14. The method of claim 1 further comprising a step of liquid chromatography prior to analyzing the sample by mass spectrometry.

15. The method of claim 1 wherein the biological sample is chosen from whole blood, blood components, frozen blood, blood spots, serum, plasma, physiological fluid, physiological tissue, inner cheek swabs, hair, cerebral spinal fluid, vitreous humor, or amniotic fluid.

16. The method of claim 1 wherein the step of analyzing comprises analysis in the positive ion mode or the negative ion mode.

17. The method of claim 1 wherein the step of analyzing the sample comprises analysis of a panel of biological samples.

18. The method of claim 17 wherein the analysis is done by a discrete mode of operation, a rastering mode of operation, or by a pattern raster mode of operation.

19. The method of claim 17 wherein the step of providing the biological sample comprises spotting the biological sample on a target surface to produce a panel of biological samples, and wherein at least one spot comprises a biological sample that is analyzed for at least two biological disorders simultaneously.

20. A method for multiplexed analysis of a panel of biological samples for biological disorders comprising:
(a) providing the panel of biological samples;
(b) spotting the panel of biological samples on a target surface; and
(c) analyzing the panel of biological samples by a laser desorption ion source coupled to a mass analyzer.

21. A kit for the analysis of a metabolic disorder, comprising one or more of:
(i) reagents for collection, preparation and/or analysis of biological samples comprising or suspected of comprising analytes of metabolic disorders for analysis by laser desorption ion source coupled to a mass analyzer; and
(ii) instructions for the collection, preparation and/or analysis of samples for analysis by laser desorption ion source coupled to a mass analyzer.

22. The kit of claim 21 wherein the metabolic disorder is a newborn metabolic disorder.

23. The kit of claim 21 for the analysis of a panel of metabolic disorders.
